(19) United States
(12) Patent Application Publication
(10) Pub. No.: US 2025/0190262 A1
(43) Pub. Date: Jun. 12, 2025

(54) HETEROGENEOUS FUNCTIONAL PROCESSING ARCHITECTURES AND METHODS TO DESIGN AND FABRICATE THE SAME

(71) Applicant: Ronald Chi-Chun HUI, Hong Kong (CN)

(72) Inventor: Ronald Chi-Chun HUI, Hong Kong (CN)

(21) Appl. No.: 18/964,643

(22) Filed: Dec. 1, 2024

Related U.S. Application Data
(60) Provisional application No. 63/607,601, filed on Dec. 8, 2023.

(51) Int. Cl. G06F 9/50; G06F 8/41; G06F 9/30

(52) U.S. Cl. CPC G06F 9/5027; G06F 8/441; G06F 9/30098

(57) ABSTRACT

The present disclosure relates to heterogeneous architecture systems and methods to design and fabricate the same. In one example, the heterogeneous architecture system includes at least one processing unit, a plurality of accelerator units, a memory subsystem connected to the at least one processing unit and the plurality of accelerator units, and at least one function arbiter connected to the at least one processing unit and the plurality of accelerator units. Other embodiments are described herein. In certain embodiments, the heterogeneous architecture system integrates various types of processing components, each optimized for specific tasks, allowing for a more efficient execution of diverse workloads.

### CROSS-REFERENCE TO RELATED APPLICATION

This application claims priority to, and the benefit of, U.S. Provisional Application Ser. No. 63/607,601 filed Dec. 8, 2023, entitled APPLICATION-SPECIFIC FUNCTIONAL PROCESSOR ENABLING HIGH-PERFORMANCE SYSTEM CODESIGN. The entire contents of the foregoing application are hereby incorporated by reference for all purposes.

### FIELD OF INVENTION

This invention relates to a heterogeneous architecture system, a computer-implemented method to design and optionally fabricate the heterogeneous architecture system, and a corresponding computer program product.

### BACKGROUND OF INVENTION

The digital design of Field-Programmable Gate Arrays (FPGAs) and System-on-Chips (SoCs) is becoming increasingly complex due to the demands of advanced applications such as AI, 5G, streaming, and computer graphics. Existing solutions, including CPUs, often struggle to meet the performance requirements of these applications, while GPUs consume excessive power, which is particularly problematic for edge applications. There is a need for an automated system design of custom hardware that can effectively address the performance, power, and cost objectives associated with these demanding applications.

### SUMMARY OF INVENTION

In the light of the foregoing background, a system with a heterogeneous multi-core architecture and a computer-implemented method to design and optionally fabricate the heterogeneous architecture system are provided.

In some embodiments, provided is a heterogeneous architecture system including (a) at least one processing unit including a processing core, wherein the processing core is configured to implement a processing core function interface including a processing core child interface and a processing core parent interface; (b) a plurality of accelerator units each including an accelerator core, wherein the accelerator core is configured to implement an accelerator core function interface including an accelerator core child interface and optionally an accelerator core parent interface; and (c) at least one function arbiter connected to the at least one processing unit and the plurality of accelerator units, wherein the at least one processing unit or one of the accelerator units operates as a parent module when sending a function call request to a child module to execute a function, wherein the child module is a designated processing unit or a designated accelerator unit; wherein the at least one function arbiter is configured to: forward one or more function call requests received from the processing core parent interface or from the accelerator core parent interface of one or more of the parent modules to the processing core child interface or to the accelerator core child interface of one or more of the child modules, and optionally forward one or more function return requests received from the processing core child interface or from the accelerator core child interface of one or more of the child modules to the processing core parent interface or to the accelerator core parent interface of one or more of the parent modules.

In some embodiments, provided is a heterogeneous architecture system including (a) at least one processing unit including a processing core and at least one memory request port connected to the processing core; (b) a plurality of accelerator units each including an accelerator core and at least one memory request port connected to the accelerator core; (c) a memory subsystem including: a plurality of memory groups, wherein each memory group includes a plurality of memory banks of a single memory type; a plurality of memory ports, wherein each memory port is configured to connect with one of the memory banks; and a plurality of request concentrators, wherein each request concentrator is configured to connect one of the memory ports with at least one memory request port of the at least one processing unit and/or at least one memory request port of at least one of the accelerator units, such that the at least one processing unit and/or the at least one of the accelerator units can access the plurality of memory banks concurrently.

In some embodiments, provided is a computer-implemented system synthesis method to design and optionally fabricate a heterogeneous architecture system, wherein the method includes the following steps: (a) conducting performance profiling to an initial software implementation of the heterogeneous architecture system to identify a set of accelerated functions that are required in the heterogeneous architecture system, wherein the initial software implementation includes a set of source codes; (b) optionally refactoring source codes of the set of accelerated functions and incorporating pragma directives to the source codes of the set of accelerated functions to produce a High-Level Synthesis (HLS) function code for HLS optimization; (c) defining a data structure of a memory subsystem in the set of source codes based on the requirements of the set of accelerated functions; (d) defining system parameters in a system configuration directed towards the heterogeneous architecture system; (e) generating or obtaining a Register Transfer Level (RTL) code for the plurality of accelerator units required for the set of accelerated functions based on: (i) the HLS function code, (ii) a native RTL code obtained from redesigning the set of accelerated functions, or (iii) a pre-existing RTL code for the set of accelerated functions; generating a RTL code for the memory subsystem based on the data structure; and generating a RTL code for the at least one processing unit and optionally a plurality of memory modules; (f) instantiating the RTL code for the plurality of accelerator units, the RTL code for the memory subsystem and the RTL code for the at least one processing unit and optionally a plurality of memory modules according to the system configuration to generate a RTL circuit model of the heterogeneous architecture system; (g) optionally generating at least one simulator software of the heterogeneous architecture system based on the RTL circuit model to assess the system performance; (h) generating a digital circuit of the heterogeneous architecture system based on the RTL circuit model; and (i) optionally fabricating the heterogeneous architecture system.

In some embodiments, provided is a computer program product loadable in a memory of at least one computer and including instructions which, when executed by the at least one computer, causes the at least one computer to carry out the steps of the computer-implemented method according to any of the examples as described herein.

Other embodiments are described herein.

### Advantages

There are many advantages of the present disclosure. In certain embodiments, the disclosed computer-implemented method to design and optionally fabricate the heterogeneous architecture system significantly reduces the development time of high-performance and complex logic designs using source codes such as C. In traditional hardware flows, designers often face a trade-off between lower design effort using Application-Specific Instruction-Set Processors (ASIP) and achieving high performance with custom accelerators. In some embodiments, the heterogeneous architecture system (also referred to as “functional processor” or “application-specific functional processor” herein) addresses the challenge of high-performance system design by seamlessly integrating processing cores (such as RISC cores), memory subsystem (also referred to as “application-specific exchanged memory” herein), function arbiters, and custom accelerators into a unified architecture. This integration empowers the processing core firmware (such as RISC firmware) to transparently utilize accelerators as software functions, enabling high-efficiency automated hardware/software co-design.

In some embodiments, the heterogeneous multi-core architecture system integrates various types of processing components, each optimized for specific tasks, allowing for a more efficient execution of diverse workloads.

In some embodiments, in the heterogeneous architecture system, the use of the same processing core function interface in each processing core for interacting with different accelerator cores offers flexibility and modularity. In conventional processor architectures, the JALR (jump-and-link register) instruction is employed for function calls. When a JALR instruction is executed, the processing core transfers control to the specified address, representing the target function. However, in some embodiments of the present disclosure, by treating each accelerator core as a “function” that can be invoked through a unified interface, the processing core simplifies the programming and control flow for utilizing various hardware accelerator cores.

In some embodiments, the processing core function interface in the heterogeneous architecture system ensures software compatibility and transparency by utilizing the same software API for both software function calls and functional accelerator cores invocations. This approach promotes a seamless integration of accelerator cores into the system, allowing developers to leverage them without significant changes to their code. It can also ensure binary compatibility when reusing the same software for chips with no accelerator core or different accelerator cores with compatible arguments. By offering a unified interface and supporting different modes of operation, the heterogeneous architecture system provides a flexible and efficient approach to incorporating hardware accelerator cores into the overall system architecture.

### BRIEF DESCRIPTION OF FIGURES

FIG. 1 is a diagram showing the top level architecture of a heterogeneous architecture system according to an example embodiment.

FIG. 2 is a diagram showing the connections between the request concentrators, data blocks in the memory subsystem (xmem) and different components according to an example embodiment.

FIG. 3 is a diagram showing the integration of a function arbiter with a processing core processing pipeline according to an example embodiment.

FIG. 4 is a diagram showing the internal architecture of a memory subsystem (xmem) according to an example embodiment.

FIG. 5 is a diagram showing connections among accelerators, processing cores and xmem in the heterogeneous architecture system according to an example embodiment.

FIG. 6A is an Address Decoding Flow Chart for access of different memory groups in xmem according to an example embodiment. FIG. 6B is an example table showing how to map each input global address to the bank group, the bank index and the bank address according to the same embodiment as FIG. 6A.

FIG. 7 is a diagram showing the connections between a processing core, an accelerator core and a request concentrator for access of data in a memory bank according to an example embodiment.

FIG. 8 is a diagram showing the connections among parent modules, child modules, a parent-child module, a call-arbiter and a return-arbiter according to an example embodiment.

FIG. 9 is a flowchart of a computer-implemented method to design and optionally fabricate a heterogeneous architecture system according to an example embodiment.

### DETAILED DESCRIPTION

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” or “containing,” is replaced with “consisting essentially of” or “consisting of”. These alternate embodiments that use “consisting of” or “consisting essentially of” are understood to be narrower embodiments of the “comprising,” “including,” or “containing,” embodiments.

For the sake of clarity, “comprising,” “including,” “containing,” and “having,” and any related forms are open-ended terms that allow for additional elements or features beyond the named essential elements, whereas “consisting of” is a closed-end term that is limited to the elements recited in the claim and excludes any element, step, or ingredient not specified in the claim.

As used herein and in the claims, “couple” or “connect” refers to electrical coupling or connection directly or indirectly via one or more electrical means unless otherwise stated.

As used herein, the terms “memory subsystem” and “xmem” refer to components within a computer system responsible for storing and retrieving data which can be concurrently accessed by different components of the system, for example one or more processing units and accelerator units to facilitate efficient data access and processing within the system.

As used herein and in the claims, “processing core” refers to an individual processor within a system. In some embodiments, the processing core is a Reduced Instruction Set Computer (RISC) core or a vector processing core. In some embodiments, the processing core is a data processing core, such as a Direct Memory Access (DMA) controller, a Level 2 (L2) Cache, or an external memory controller.

As used herein and in the claims, “High-Level Synthesis (HLS)” refers to a method of electronic design automation in which high-level functional descriptions, typically written in programming languages such as C, C++, or SystemC, are automatically converted into hardware implementations (e.g., register-transfer level (RTL) code). This process allows complex algorithms and operations to be transformed into optimized hardware implementations, capable of being mapped onto FPGA or ASIC platforms.

As used herein and in the claims, the terms “arbitrate” and “arbitrated” refer to the process and the accomplished state of managing and controlling access to a shared resource by resolving competing requests from multiple sources.

As used herein and in the claims, “contention” refers to a state where multiple sources simultaneously request access to a shared resource, resulting in a conflict over resource allocation.

As used herein and in the claims, “write-back” refers to a memory management process in which modified or updated data held temporarily in a cache or local storage is written back to a main memory or a more persistent storage location. Write-back ensures data consistency by transferring updates from high-speed, local storage to the shared memory resource when necessary.

As used herein and in the claims, “function” refers to a discrete block of executable code designed to perform a specific operation or set of operations within a larger program. In a heterogeneous core system, a function can be called or invoked by different cores to execute its predefined task, with parameters passed to it as arguments and results returned upon completion.

As used herein and in the claims, “memory banks” refers to sections or modules within a memory subsystem where data is stored. In some embodiments, memory banks includes banks of memory or cache of a single memory type.

As used herein and in the claims, “scalar cache” refers to a type of cache memory optimized for handling scalar data, which involves single data values rather than arrays or vectors processed in parallel.

As used herein and in the claims, “cyclic cache” refers to a cache that provides a wide data bus to allow multiple consecutive words to be read or written.

As used herein and in the claims, “vector cache” refers to a cache memory optimized for handling vector data or SIMD (Single Instruction, Multiple Data) operations.

As used herein and in the claims, the term “source codes” refers to high-level programming language codes, such as C/C++. In some embodiments, the source codes provide basis for a HLS tool to generate hardware implementations (e.g., register-transfer level (RTL) code).

As used herein and in the claims, the terms “instantiate” or “instantiating” refer to creating a specific instance of a hardware component or module based on a description in the high-level code with HLS tools.

As used herein and in the claims, the term “fabricate” refers to the physical manufacturing or creation of hardware based on the hardware description produced by, for example, a HLS process. In some embodiments, the fabrication process includes operating an integrated circuit fabrication machinery to manufacture the circuitry of a system (for example, the heterogeneous architecture system) based on the RTL circuit model of the system passed to the integrated circuit fabrication machinery.

In some embodiments, provided is a heterogeneous architecture system including (a) at least one processing unit including a processing core, wherein the processing core is configured to implement a processing core function interface including a processing core child interface and a processing core parent interface; (b) a plurality of accelerator units each including an accelerator core, wherein the accelerator core is configured to implement an accelerator core function interface including an accelerator core child interface and optionally an accelerator core parent interface; and (c) at least one function arbiter connected to the at least one processing unit and the plurality of accelerator units, wherein the at least one processing unit or one of the accelerator units operates as a parent module when sending a function call request to a child module to execute a function, wherein the child module is a designated processing unit or a designated accelerator unit; wherein the at least one function arbiter is configured to: forward one or more function call requests received from the processing core parent interface or from the accelerator core parent interface of one or more of the parent modules to the processing core child interface or to the accelerator core child interface of one or more of the child modules, and optionally forward one or more function return requests received from the processing core child interface or from the accelerator core child interface of one or more of the child modules to the processing core parent interface or to the accelerator core parent interface of one or more of the parent modules.

For the sake of clarity, the designated processing unit or the designated accelerator unit is not the at least one processing unit or one of the accelerator units operating as the parent module.

In some embodiments, the at least one function arbiter includes a call arbiter and a return arbiter, wherein the call arbiter is configured to receive the function call requests from one or more of the parent modules, arbitrate contentions among the function call requests, and forward the arbitrated function call requests to one or more of the child modules, wherein the call arbiter optionally comprises one or more task queues to buffer the function call requests during arbitration; wherein the return arbiter is configured to receive the function return requests from one or more of the child modules after one or more of the child modules finish executing the functions, arbitrate contentions among the function return requests, and forward the arbitrated function return requests to one or more of the parent modules, wherein the return arbiter optionally comprises one or more result queues to buffer the function return requests during arbitration. In some embodiments, both the request arbiter and the return arbiter optionally buffer the function call requests/function return requests blocked by contentions for requesting later.

In some embodiments, the processing core further includes a general purpose register (GPR) file and a shadow argument register file, wherein the processing core is configured to continuously duplicate one or more argument registers from the GPR file to the shadow argument register file, and when the processing core is sending a function call request, the processing core is configured to forward the argument registers from the shadow argument register file to the processing core parent interface.

In some embodiments, the shadow argument register file and the GPR file have the same number of argument registers, and the shadow argument register file is configured to continuously monitor a write-back status of the one or more argument registers in the GPR file to ensure that the one or more argument registers in the shadow argument register file are synchronized with the one or more argument registers in the GPR file.

In some embodiments, each of the function call requests further includes: a child module index to identify the child module designated for the function call request; up to N function arguments, wherein N is a maximum number of function arguments the parent module is able to send; and a parent module index to identify the parent module that sends the function call request, wherein the child module is configured to: store the parent module index upon receiving the function call request; and retrieve the parent module index as a destination of the function return request after executing a function requested by the function call request if a return result of executing the function is required by the parent module.

In some embodiments, if the child module of the function call request is the at least one processing unit, the function call request further includes a target program counter (PC) value of the function to be executed by the processing core of the at least one processing unit, and the child module is further configured to: interrupt an operation of the processing core and save an execution context of the operation; extract the target PC value and function arguments from the call arbiter by the processing core child interface; optionally copy the function arguments from the call arbiter to a GPR file of the processing core; executing the function starting from the target PC value; and restoring the execution context and resume executing the operation.

In some embodiments, if the child module of the function call request is one of the accelerator units, the child module is configured to: fetch one or more function arguments from the call arbiter; and/or fetch one or more function arguments from the memory subsystem by sending one or more memory requests to the memory subsystem.

In some embodiments, the accelerator core of each of the accelerator units is encapsulated as an accelerator functional thread in the processing core of the at least one processing unit, wherein the processing core is configured to: determine whether a target PC value of an instruction matches a specific accelerator functional thread; and if the target PC value matches the specific accelerator functional thread, send a function call request to the accelerator core corresponding to the specific accelerator functional thread.

In some embodiments, the at least one processing unit further includes at least one memory request port connected to the processing core; each of the accelerator units further includes at least one memory request port connected to the accelerator core; the system further includes memory subsystem including: a plurality of memory groups, wherein each memory group includes a plurality of memory banks of a single memory type; a plurality of memory ports, wherein each memory port is configured to connect with one of the memory banks; a plurality of request concentrators, wherein each request concentrator is configured to connect one of the memory ports with at least one memory request port of the at least one processing unit and/or at least one memory request port of at least one of the accelerator units, such that the at least one processing unit and/or the at least one of the accelerator units can access the plurality of memory banks concurrently.

In some embodiments, the plurality of request concentrators are connected with the at least one processing unit and the plurality of accelerator units via a static connection and/or a dynamic connection, wherein one or more of the request concentrators connect with the at least one processing unit and one or more of the accelerator units by the dynamic connection configured with a memory switch at a run time; and wherein one or more of the request concentrators connect with one or more of the accelerator units via the static connection.

In some embodiments, the system further includes a custom glue logic configured to connect individual memory request port of at least one of the accelerator units with one of the request concentrators, such that the individual memory request port has a custom connection with the memory port connected with one of the request concentrators.

In some embodiments, the system further includes a memory switch configured to coordinate communication between the memory subsystem and the at least one processing unit and/or at least one of the accelerator units, wherein the memory switch includes: an access arbiter configured to forward memory requests of the at least one processing unit and/or at least one of the accelerator units to the plurality of request concentrators; and a read-data arbiter configured to forward read data retrieved from one or more of the memory banks to the at least one memory request port of the at least one processing unit and/or the at least one memory request port of at least one of the accelerator units in response to the memory requests from the at least one processing unit and/or at least one of the accelerator units.

In some embodiments, the access arbiter includes: a plurality of input ports connected to the at least one memory request port of the at least one processing unit and/or the at least one memory request port of at least one of the accelerator units; and each request concentrator for each memory port includes at least one input port connected with an output port of the memory switch and at least one input port connected with the customer glue logic, such that the at least one processing unit and/or each accelerator unit can connect dynamically to any memory port via the memory switch for data access.

In some embodiments, each of the memory banks comprises a plurality of memory words, wherein each of the memory words is associated with a distinct global address, and each of the memory groups is assigned with a distinct global address range covering the global addresses of all memory words of the memory banks within the memory group, wherein the system further comprises an address decoder, wherein upon receiving an input global address in a memory request made by the at least one processing unit and/or at least one of the accelerator units to access a target memory word in a target memory bank within a target memory group, the address decoder is configured to locate the target memory bank and the target memory word using an address decoding scheme comprising the following steps: comparing the input global address against the global address range assigned to each of the memory groups to determine the target memory group that associates with the input global address; and decoding a bank index and a bank address from the input global address, wherein the bank index identifies the target memory bank within the target memory group and the bank address identifies the location of the target memory word within the target memory bank.

In some embodiments, the input global address includes a set of address bits having a least significant segment, a most significant segment and a middle segment, and wherein the memory type of each of the memory groups is a register-file bank or a cache bank, wherein if the memory type of the target memory group is the register-file bank, the least significant segment determines the bank index and the middle segment determines the bank address; and if the memory type of the target memory group is the cache bank, the middle segment determines the bank index while the least significant segment determines the bank address.

In some embodiments, the cache bank is selected from the group consisting of scalar cache bank, vector cache bank, and cyclic cache bank.

In some embodiments, the memory switch is a memory bus, a memory crossbar, or an on-chip router.

In some embodiments, the processing core of the at least one processing unit is selected from the group consisting of a Reduced Instruction Set Computer (RISC) core, a vector processing core, a data processing core, a Direct Memory Access (DMA) controller, a Level 2 (L2) Cache, and an external memory controller.

In some embodiments, the accelerator core of each accelerator unit is selected from the group consisting of fixed-function accelerator, reconfigurable logic block, Field Programmable Gate Arrays (FPGAs), and Coarse-Grained Reconfigurable Arrays (CGRAs).

In some embodiments, provided is a computer-implemented method to design and optionally fabricate a heterogeneous architecture system according to any of the examples as described herein, wherein the method includes the following steps: (a) conducting performance profiling to an initial software implementation of the heterogeneous architecture system to identify a set of accelerated functions that are required in the heterogeneous architecture system, wherein the initial software implementation includes a set of source codes; (b) optionally refactoring source codes of the set of accelerated functions and incorporating pragma directives to the source codes of the set of accelerated functions to produce a High-Level Synthesis (HLS) function code for HLS optimization; (c) defining a data structure of a memory subsystem in the set of source codes based on the requirements of the set of accelerated functions; (d) defining system parameters in a system configuration directed towards the heterogeneous architecture system; (e) generating or obtaining a Register Transfer Level (RTL) code for the plurality of accelerator units required for the set of accelerated functions based on: (i) the HLS function code, (ii) a native RTL code obtained from redesigning the set of accelerated functions, or (iii) a pre-existing RTL code for the set of accelerated functions; generating a RTL code for the memory subsystem based on the data structure; and generating a RTL code for the at least one processing unit and optionally a plurality of memory modules; (f) instantiating the RTL code for the plurality of accelerator units, the RTL code for the memory subsystem and the RTL code for the at least one processing unit and optionally a plurality of memory modules according to the system configuration to generate a RTL circuit model of the heterogeneous architecture system; (g) optionally generating at least one simulator software of the heterogeneous architecture system based on the RTL circuit model to assess the system performance; (h) generating a digital circuit of the heterogeneous architecture system based on the RTL circuit model; and (i) optionally fabricating the heterogeneous architecture system.

In some embodiments, one or more of steps (a)-(h) of the computer-implemented system are performed using a tool chain including a HLS tool, a memory subsystem generation tool and a system generation tool, wherein step (e) includes the following steps: (e1) generating, by the HLS tool, the RTL code for the plurality of accelerator units; (e2) generating, by the memory subsystem generation tool, the RTL code for the memory subsystem; and (e3) generating, by the system generation tool, the RTL code for the at least one processing unit and optionally the plurality of memory modules; wherein the instantiating step in step (f) is performed by the system generation tool.

In some embodiments, step (f) of the computer-implemented method includes the following steps: (f1) analyzing the set of source codes to determine an address range in the memory subsystem as requested by the at least one memory request port of individual accelerator unit; (f2) decoding a destined memory bank associated with the address range using an address decoding scheme to identify the memory port coupled with the destined memory bank; (f3) assigning a static connection between the at least one memory request port and a request concentrator of the memory subsystem connected with the memory port of the destined memory bank when generating the RTL circuit model.

In some embodiments, step (c) of the computer-implemented method includes the following steps: (c1) generating a custom memory block corresponding to each data member of the data structure; (c2) editing configurable parameters of each memory block based on the requirements of the set of accelerated functions, wherein the configurable parameters include one or more of memory type, memory depths and widths, number of read/write ports associated with the memory block, and connections with at least one of the accelerator units and/or at least one processing unit.

In some embodiments, provided is a computer program product loadable in a memory of at least one computer and including instructions which, when executed by the at least one computer, causes the at least one computer to carry out the steps of the computer-implemented method according to any of the examples as described herein.

In some embodiments, provided is a computer readable medium including instructions which, when executed by at least one computer, causes the at least one computer to carry out the steps of the computer-implemented method according to any of the examples as described herein.

In some embodiments, provided is a computer system including at least one memory, at least one processor and a computer program stored in the at least one memory, wherein the at least one processor executes the computer program to carry out the steps of the computer-implemented method according to any of the examples as described herein.

In some embodiments, provided is a heterogeneous architecture system including (a) at least one processing unit including a processing core and at least one memory request port connected to the processing core; (b) a plurality of accelerator units each including an accelerator core and at least one memory request port connected to the accelerator core; (c) a memory subsystem including: a plurality of memory groups, wherein each memory group includes a plurality of memory banks of a single memory type; a plurality of memory ports, wherein each memory port is configured to connect with one of the memory banks; and a plurality of request concentrators, wherein each request concentrator is configured to connect one of the memory ports with at least one memory request port of the at least one processing unit and/or at least one memory request port of at least one of the accelerator units, such that the at least one processing unit and/or the at least one of the accelerator units can access the plurality of memory banks concurrently.

In some embodiments, the system further includes a memory switch configured to coordinate communication between the memory subsystem and the at least one processing unit and/or at least one of the accelerator units, wherein the memory switch includes: an access arbiter configured to forward memory requests of the at least one processing unit and/or at least one of the accelerator units to the plurality of request concentrators; and a read-data arbiter configured to forward read data retrieved from one or more of the memory banks to the at least one memory request port of the at least one processing unit and/or the at least one memory request port of at least one of the accelerator units in response to the memory requests from the at least one processing unit and/or at least one of the accelerator units.

In some embodiments, the access arbiter includes: a plurality of input ports connected to the at least one memory request port of the at least one processing unit and/or the at least one memory request port of at least one of the accelerator units; and a plurality of output ports connected to the plurality of request concentrators, such that the at least one processing unit and/or each accelerator unit can connect dynamically to any memory port via the memory switch for data access.

In some embodiments, each of the memory banks comprises a plurality of memory words, wherein each of the memory words is associated with a distinct global address, and each of the memory groups is assigned with a distinct global address range covering the global addresses of all memory words of the memory banks within the memory group, wherein the system further comprises an address decoder, wherein upon receiving an input global address in a memory request made by the at least one processing unit and/or at least one of the accelerator units to access a target memory word in a target memory bank within a target memory group, the address decoder is configured to locate the target memory bank and the target memory word using an address decoding scheme comprising the following steps: comparing the input global address against the global address range assigned to each of the memory groups to determine the target memory group that associates with the input global address; and decoding a bank index and a bank address from the input global address, wherein the bank index identifies the target memory bank within the target memory group and the bank address identifies the location of the target memory word within the target memory bank.

In some embodiments, the input global address includes a set of address bits having a least significant segment, a most significant segment and a middle segment, and wherein the memory type of each of the memory groups is a register-file bank or a cache bank, wherein if the memory type of the target memory group is the register-file bank, the least significant segment determines the bank index and the middle segment determines the bank address; and if the memory type of the target memory group is the cache bank, the middle segment determines the bank index while the least significant segment determines the bank address.

In some embodiments, the cache bank is selected from the group consisting of scalar cache bank, vector cache bank, and cyclic cache bank.

In some embodiments, the memory switch is a memory bus, a memory crossbar, or an on-chip router.

In some embodiments, the system further includes a custom glue logic configured to connect individual memory request port of at least one of the accelerator units with one of the request concentrators, such that the individual memory request port has a custom connection with the memory port connected with one of the request concentrators.

### Example 1

### Application-Specific Functional Processor Enabling High-Performance System Codesign

In some embodiments, the functional processor significantly reduces development time of high-performance and complex logic designs using C. In traditional hardware flows, designers often face a trade-off between lower design effort using Application-Specific Instruction-Set Processors (ASIP) and achieving high performance with custom accelerators. In some embodiments, the functional processor addresses the challenge of high-performance system design by seamlessly integrating RISC cores, application-specific exchanged memory, functional interfaces and custom accelerators into a unified architecture. This integration empowers RISC firmware to transparently utilize accelerators as software functions, enabling automated hardware/software codesign with high efficiency. C programmers can write C code to generate the application-specific functional system using the example functional tool chain and existing High-Level Synthesis (HLS) tools.

### Problem: Design Automation of Custom Hardware

In some embodiments, by offloading computationally intensive tasks to custom hardware, the processing core is relieved of iterative tasks and it can focus on less frequently executed system-level functions such as setting parameters, initialization, DMA control and serial operations. While custom hardware maximizes performance of certain accelerated functions, this custom hardware needs to be seamlessly integrated into a larger system that includes at least one processing core. Therefore, careful consideration must be given to the impact of hardware/software codesign on the overall system performance. Achieving optimal performance necessitates a system-level optimization that takes into account the interaction between the custom hardware and the software as well as multi-thread scheduling.

### Requirements of High-Performance Codesign

In some embodiments, high-performance digital design utilizes a holistic approach to optimize overall hardware/software codesign, rather than focusing solely on accelerator performance. The programmer decides how to partition software functions and determine which functions should be executed in software and which ones should be accelerated using custom hardware. It also involves careful analysis of the data flow between functions to design an efficient memory hierarchy and plan DMA (Direct Memory Access) operations accordingly.

### Hardware Acceleration Strategy

In some embodiments, the initial step of software/hardware codesign is performance profiling, where the most frequently executed functions are identified as potential candidates for hardware acceleration. To estimate the overall speedup resulting from hardware acceleration, Amdahl's law provides a useful framework. Amdahl's law states that the overall speedup of a system is determined by the parallel fraction (p) and the speedup(s) achieved by accelerating that fraction. The overall speedup S can be mathematically expressed as:

S=1/(1−p+(p/s))

Here, the parallel fraction (p) represents the percentage of the workload (in terms of cycle count) that can be effectively speedup with custom accelerators, while the speedup(s) denotes the average speed-up in cycle count achieved by the custom accelerators. In some embodiments, the design process may require iterations of adding hardware accelerators and repeating the profiling steps until the desired overall speedup is achieved.

In some embodiments, complex algorithms consist of the following type of functions:

1. Hot spot functions: Highly parallel iterative computations applied on large data vectors. Hardware acceleration can result in higher speed up due to their inherent data parallelism.

2. Long-tail functions: These functions cannot be easily accelerated through parallel processing alone. However, they involve complex serial operations that can benefit from fusing multi-cycle serial operations into one-cycle operation. They often have significant interactions with other software functions or hot spot accelerators.

3. Trivial functions: These functions involve simple workloads that can be executed efficiently using general-purpose RISC cores without the need for acceleration.

In some embodiments, the function profiling of these functions typically exhibits long-tail distribution. The number of hotspot functions is the smallest, followed by long-tail functions, and the number of trivial functions is the largest. Additionally, the computational workload of these functions follows a similar pattern: hotspot functions have the highest computation workload, followed by longtail functions, and then trivial functions.

In some embodiments, high performance applications demand high overall speedup S. According to Amdahl's law, if S is large, p has to be large too. Focusing solely on accelerating hotspot functions may result in poor speedup. To improve overall performance, it is crucial to increase the portion of functions that are hardware accelerated. In some embodiments, this includes not only iterative hotspot functions but also long tail functions, which may involve scalar data but still contribute significantly to the workload. Furthermore, Amdahl's law is applied for single thread only. If software can create multi-threaded software to treat each accelerator as a separate thread, the accelerators can run in parallel to get even higher speedup. In some embodiments, an effective codesign strategy involves instantiating a few high-performance accelerators for hotspot functions and more medium-performance accelerators for long-tail functions. Each accelerator can support multithreading, enabling efficient utilization of resources. Trivial functions can be executed as embedded software on one or multiple RISC cores to achieve good-enough performance without the need for specialized acceleration.

One example includes accelerating the open-source HEVC decoder software, namely openHEVC. Profiling shows that decoding 1080p video at 60 frames per second requires approximately 15 billion instructions on a RISC-V core. This workload is too demanding for even the fastest RISC core and calls for acceleration.

Hotspot functions, which account for around 70% of all executed instructions at ˜10,000 MIPS, include:
Idct_16×16
Idct_8×8
Pred_angular
Transform_add16×16
Pred_plana
Intra_pred

Long-tail functions, representing roughly 28% of the workload at 4200 MIPS, include:
hevc_decode_frame
hls_coding_quadtree
hevc_parse
hls_transform_tree
ff_hevc_hls_residual_coding
ff_hevc_extract_rbsp
Ff_hevc_deblocking_boundary_strengths

Trivial functions account for approximately 2% of the workload, totaling 300 million instructions per second (MIPS).

In this example, without any acceleration, the CPU would need to run at 15 least GHz to handle the workload.

By accelerating only the hotspot functions with a speedup of 40×, the system speedup(S) can be calculated using Amdahl's law as S=1/(0.3+0.7/40), resulting in a speedup of approximately 3×. This allows the system frequency to be reduced to around 5 GHz but it is still difficult to run efficiently at 5 GHz by most high-end processors.

In this example, provided herein is a practical and efficient solution by employing hotspot and long-tail acceleration with multi-threading, assuming a 40× speedup for hotspot functions, a 20× speedup for long-tail functions, and no speedup for the remaining functions. Thread 1 handles all the hotspot functions, requiring 10 billion instructions at a frequency of 250 MHz due to 40× speedup. Thread 2 executes the long-tail and trivial functions, with long-tail functions running at 210 MHz (4.2 GIPS/20) and trivial functions using 300 MHz. Therefore, thread 2 operates at a frequency of 510 MHz. The system frequency is determined by the maximum frequency of the two threads, which in this case is 510 MHz.

In this example, by leveraging hotspot acceleration, long-tail acceleration, and multi-threading, the overall operating frequency can be significantly reduced from 15 GHz to ˜510 MHz, roughly 30×speedup. It enables decoding of 1080p video at 60 frames per second with low power and low cost.

### Dataflow Management

In one embodiment, the following is some observation of 32-bit energy costs at 0.9V 45 nm:

TABLE 1
32-bit energy costs at 0.9 V 45 nm

| Operation | Energy Cost (pJ) | Energy Ratio |
|---|---|---|
| Add | 0.1 | 1x |
| Multiplier | 3 | 3-x |
| 32 KB cache | 10 | 100x |
| 1 MB cache | 50 | 500x |
| DDR | 600~1200 | 6000~12000x |

As shown in table 1, logic operations are cheap but memory operations are expensive. Small memory blocks consume less power than large memory blocks and on-chip memory consumes less power than external DDR memory. In short, registers and memory blocks with smaller storage capacity have higher speeds and lower powers.

In order to reduce power, memory hierarchy is defined based on application-specific power, performance, cost and data storage requirements. DDR is only needed if the memory used cannot fit in on chip memory. Adding L2 memory can minimize or even get rid of DDR access. Furthermore, by utilizing DMA operations to schedule data prefetching from L2 memory to L1 memory, the storage capacity of the L1 cache can be reduced without sacrificing performance significantly. Consequently, utilizing larger shared memory blocks among accelerators is more cost- and power-efficient than dedicating many smaller memory blocks to each accelerator. Xmem is a highly efficient, multi-ported memory solution designed to achieve this goal.

In some embodiments, simulators and performance analysis tools are employed to explore the design space of different memory hierarchies. Simulations allow for evaluating the performance and power characteristics of various memory configurations and finding the optimal balance between power consumption and performance. This facilitates the identification of the most efficient memory hierarchy for the given requirements.

### Functional Processor

In some embodiments, functional processor is an application-specific architecture aiming to accelerate entire functions by codesign of software and custom hardware, rather than focusing on individual instructions, which has only limited parallelism. Besides of a RISC core and a couple of custom accelerators, a functional processor consists of the following unique components:
Application-specific exchange memory (xmem)
Function arbiter

In some embodiments, the RISC core controls different custom accelerators via the function arbiter. The RISC core also exchanges large data structures with accelerators via xmem. Furthermore, different custom accelerators can also exchange data structure among themselves via xmem.

This modular synthesis approach provides the flexibility of breaking down a large monolithic accelerator into smaller modules to exchange data among accelerators efficiently. It also enables programmers to achieve fine control over the quality-of-results for each accelerator generated through high-level synthesis (HLS) by precise tuning and optimization of HLS pragma of individual accelerators. Furthermore, the modular design facilitates flexible reuse of smaller hardware blocks via software control, promoting efficient resource utilization and enhancing design flexibility. For instance, if several parent functions share the same child functions in the reference software, the generated hardware may have multiple accelerators corresponding to parent functions sharing the accelerator corresponding to the child function.

When compared to Application-Specific Instruction-Set Processors (ASIPs), the RISC core in a functional processor does not require custom compiler or processor architecture for specific functions. Instead, the RISC core utilises a basic reduced instruction set architecture, enabling faster clock frequency and lower power for generic software functions.

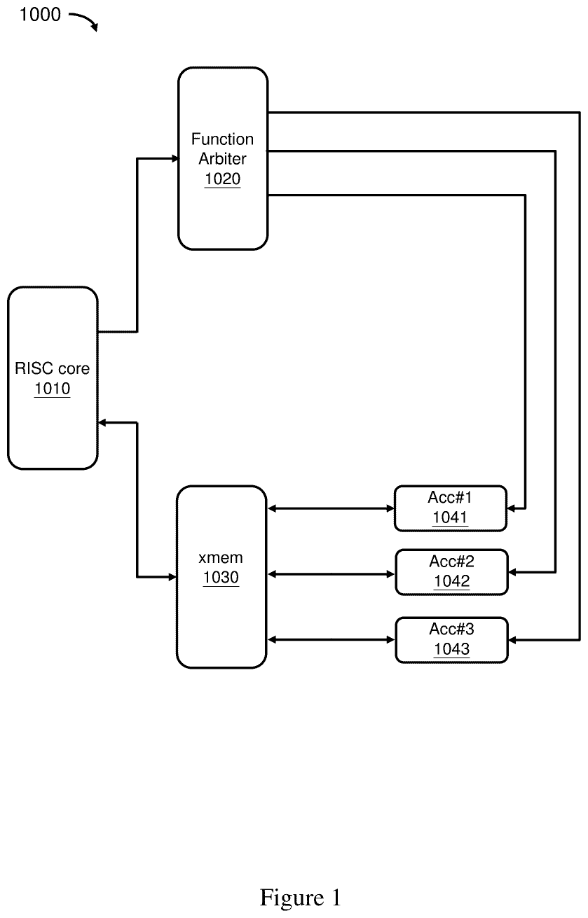

FIG. 1 illustrates one example implementation of a basic functional processor which consists of a RISC-core, a function arbiter, xmem and multiple accelerators. Both the RISC core and multiple accelerators connect with xmem to exchange data. Meanwhile, the RISC core has another control path to all accelerators via the function arbiter. In a more generic implementation, there are R RISC cores connecting with X xmem modules via a first bus or switch. Meanwhile these xmem are further connected with A accelerators via a second bus or switch. Moreover, each RISC has its own functional interfaces to connect with some or all accelerators. The generic configurations creates a scalable network to enable data sharing among many RISC core and many accelerators via multiple xmem.

Shared Application-Specific Exchange Memory (xmem)

Existing accelerators usually use dedicated application-specific memory and/or registers and so data exchange with other modules is not allowed. However, in most production-quality software code for high performance applications, hot-spot functions, long-tail functions and trivial functions usually exchange pointers or references of complex data structures among themselves without additional data exchange overhead due to passing function arguments or copying data arrays and structures. Efficient access of shared structure among different accelerators and RISC cores is one of the necessary conditions to enable efficient hardware acceleration.

In some embodiments, a functional processor employs an application-specific shared memory as a central hub for quick data exchange among processors, accelerators and the DMA controller. The function processor tool chain can generate custom hardware connections between accelerators and the requested xmem data member according to C code. The data width can be as wide as needed by accelerators to meet the performance required. Meanwhile, the RISC-core and DMA controller may connect with all or a subset data member of xmem with a scalar connection, where the data width is typically the same as the processor data width.

In some embodiments, the xmem is defined as a data structure in C code or any other programming language. The tool chain generates a custom data block in hardware corresponding to each data member of the structure in the source code. Different design parameters of the data blocks can be configured depending on application-specific requirements. The configurable parameters of each data block include:
Storage type
Depths and widths
Number of read/write ports
connections with accelerators and RISC core

In some embodiments, the depths and widths can be inferred from C data structure. The number of ports in each data block depends on the number of parallel read and write operations required by the accelerators and so the number of ports can be inferred from the verilog code corresponding to each accelerator. There are mainly two storage types, namely register or memory blocks:
1. Register or Register Array: If a data block is a register or register array, it can provide 1 to N read/write ports, where N is larger than 2.
2. Memory Block: If a data block is a memory block, it typically provides 1 to 2 read/write ports, depending on the capability of the memory compiler used in digital logic synthesis.

In some embodiments, the selection of storage types depends on the number of read/write ports and the memory size. If the number of ports is larger than 2, only the register-type data block can be used. On the other hand, when the number of access ports is fewer than 2 and the memory depth is large, it becomes more cost-effective to utilize memory-type data blocks instead of registers. However, if the data block size is relatively small, it is preferable to use registers instead. Furthermore, each data block may be distributed in more than one register or memory bank so that multiple banks can be accessed in parallel if there is no bank conflict.

In some embodiments, connections between accelerators and data blocks are also configurable depending on whether an accelerator needs to read from or write to a specific data block. Each read/write port of each data block in xmem is allocated with an request concentrator. These request concentrators enable either one of the custom accelerators, the RISC core or the DMA controller to access a specific port at any given time. Meanwhile, different modules can access different ports of different data blocks in parallel.

In some embodiments, C programmers have to minimize the xmem storage capacity to avoid a timing critical path during high-speed operation of the custom accelerators since smaller memory blocks can run faster. The DMA controller plays a crucial role in transferring data between the xmem and one of other larger memory blocks in the system, which may be the L1 cache, L2 cache, or external DDR chip. These operations ensure efficient data movement by performing just-intime DMA operations, thus preventing the accelerators from under-utilization caused by waiting for data to be fetched. Ensuring the accelerators to access the required data without unnecessary delays enhances the utilization of the accelerators and maximizes the overall system throughput. If hardware is not fully utilized, it may require over-design of the accelerator to meet the required performance, which in turn reduces area and power efficiency. Therefore, it is advantageous to configure DMA access to the xmem via arbiters if high-speed data transfer is needed.

Furthermore, in some embodiments, extension to enable caching of xmem is also possible, allowing for additional capabilities of detecting cache misses by tag mismatches, refilling missed data from the next-level memory to different xmem data members and writing back dirty xmem data to the next-level memory. This cache extension also enables xmem malloc and recursive operations to be applied on xmem.

By configuring and connecting the appropriate xmem data blocks based on the requirements of the accelerators and the storage capacity needed, the functional processor ensures highspeed data access and exchange among RISC cores, DMA controllers and accelerators.

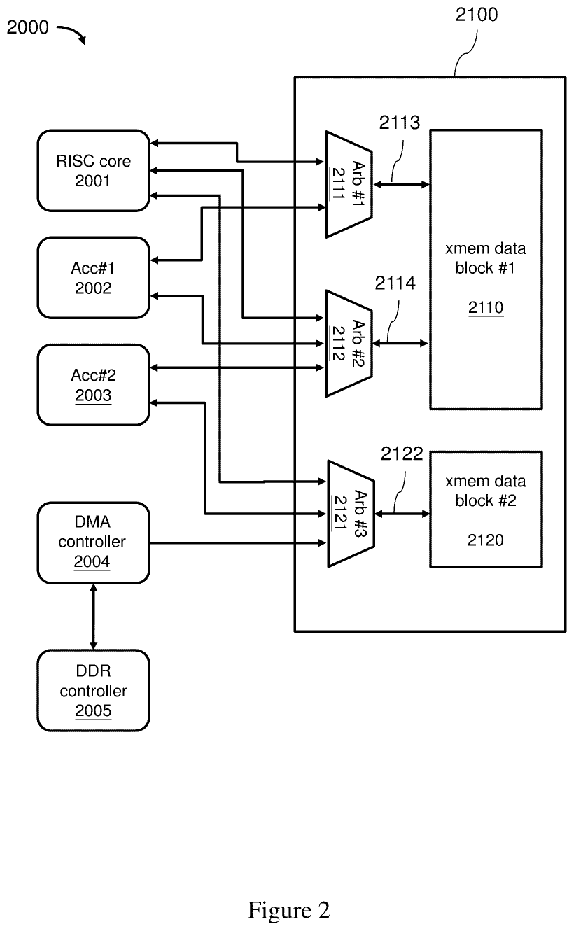

FIG. 2 shows an example of how a RISC core, a DMA controller and 2 hardware accelerators access a xmem consisted of 2 data blocks via 3 request concentrators, where block1 is a dual ported RAM and block2 is a single-ported RAM. Table 2 illustrates the configurable connections among different components and different memory ports.

TABLE 2
example configurable connections among a
RISC core, a DMA controller, 2 hardware
accelerators and different memory ports

| | block1.port1 | block1.port2 | block2.port1 |
|---|---|---|---|
| RISC core | ✓ | ✓ | ✓ |
| Accelerator #1 | ✓ | ✓ | |
| Accelerator #2 | | ✓ | ✓ |
| DMA controller | | | ✓ |

In this example, DMA controller is connected to xmem and DDR controller and so it can prefetch DDR data to be used by the RISC core and accelerator #2.

### Functional Interface

In some embodiments, the RISC firmware treats functional accelerators as another RISC core running application specific functions independently, namely functional threads. A functional interface is established to facilitate efficient passing of function arguments from the RISC core to accelerators. Furthermore, some function arguments may represent pointers to some xmem data members, thus effectively passing data structures without overhead.

### Shadow Argument Register File

In most RISC architectures, such as RISC-V, a subset of registers is designated for passing function arguments. Specifically, in RISC-V, function arguments are passed using registers a0 to a7. In some embodiments, to facilitate parallel passing of argument registers from RISC core to function accelerators, a shadow argument register file is used. This shadow argument register file has the same number of argument registers as the RISC argument registers and it mirrors the GPR data contents. The shadow argument register file continuously monitors the write-back status of the general purpose registers (GPR). Whenever the RISC writes back to any GPR and the register index belongs to one of the argument registers, the shadow buffer copies the write-back result of the corresponding argument register. This ensures that the shadow argument register file stays synchronised with the latest values in GPR. In the case of RISC-V, a0 to a7 corresponds to r10 to r17. The index of the destination register rd of corresponds to 10 to 17. When detecting write-back of register rd, the shadow buffer writes back the contents to the (rd-10)th register in the shadow argument register file accordingly.

In some embodiments. while the shadow argument register file allows for one register to be written back with the RISC result, it also allows for parallel fetching one to N shadow argument registers as function arguments when calling a function. Here, N represents the largest number of argument registers to be passed. This enables no cycle penalty to be incurred due to argument passing during function calls. The general purpose register file is tightly integrated in the RISC pipeline. Its design affects the timing critical path of the RISC core. Duplicating argument registers from general purpose register file to the shadow argument register file ensures the timing paths related to general purpose register files are not affected due to parallel access of argument registers.

### Function-Call Transparency

In some embodiments, the functional processor's approach of reusing the same functional interface for different accelerators offers flexibility and modularity. By treating each accelerator as a “function” that can be invoked through a unified interface, the RISC core simplifies the programming and control flow for utilizing various hardware accelerators.

In most processor architectures, the JALR instruction is commonly employed for function calls. When a JALR instruction is executed, the RISC core transfers control to the specified address, representing the target function. However, in a functional processor, the functional interface takes on a different role.

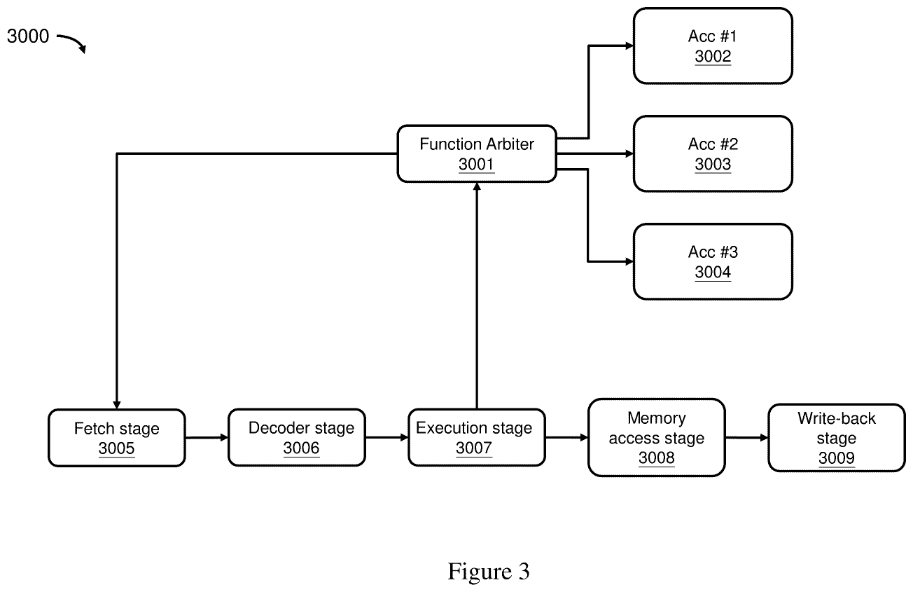

In some embodiments, the functional interface of the functional processor has a call interface which examines the target PC value and performs decoding operations to determine whether it corresponds to a functional accelerator or a normal software function call. If it is a software function call, it operates in the same manner as existing processors, following the established conventions. On the other hand, if the target PC matches one of the functional accelerators, the functional interface activates the corresponding accelerator and transmits the variable number arguments depending on the functions being called. FIG. 3 shows how the call interface of the function interface is integrated into the RISC processing pipeline.

In some embodiments, the RISC can create a functional thread in a blocking or non-blocking mode. If using blocking mode, the RISC core simply stalls until the requested functional accelerator completes its operation and it is ready to process a new request. If using non-blocking mode, the RISC core continues executing the subsequent instructions, potentially fetching the accelerator's result later when triggered by interrupt or mutex signalling. This mode allows for more concurrent and parallel execution within the functional processor. Meanwhile, a data member of the xmem used by the destined function accelerators will be locked by mutex mechanism and the functional accelerator will free it later when it finishes execution the function.

Another function required by non-blocking mode is task queue. If the function accelerator is busy when a function is called, the function arguments are pushed to a task queue and the destined functional accelerator pops the argument later when it is free. In some embodiments, to maximize efficiency, a functional processor can utilize a memory block with a wide data path to store the function arguments. It can push multiple function arguments simultaneously, taking advantage of the parallelism provided by the wide data path. Let's assume the width of the data path is W, indicating the number of arguments that can be accessed in one cycle. Consider a memory block with a wide data path that can push or pop W arguments in each cycle. Now, suppose there is a target functional accelerator that requires N′ arguments. In a non-blocking mode, it would take N′/W cycles to pass all the required arguments to the accelerator.

Regardless of the mode, the functional interface ensures software compatibility and transparency by utilizing the same software API for both software function calls and functional accelerator invocations. This approach promotes a seamless integration of accelerators into the system, allowing developers to leverage them without significant changes to their code. It can also ensure binary compatibility when reusing the same software for chips with no accelerator or different accelerators with compatible arguments. By offering a unified interface and supporting different modes of operation, functional processors provide a flexible and efficient approach to incorporating hardware accelerators into the overall system architecture.

### Functional Tool Chain

In some embodiments, functional synthesis tool chain encompasses multiple components: an existing High-Level Synthesis (HLS) tool, xmem generation, and a system generation tool.

The process commences with the programmer writing C code, serving as the initial software implementation. The following steps are involved:
Conducting performance profiling to identify accelerated functions.
Refactoring the C code of accelerated functions and incorporating pragma directives for HLS optimization.
Defining the xmem data structure based on the requirements of the accelerated functions.

The xmem width and depth can be deduced from xmem related pragma, such as Xilinx HLS pragma of array partition. Each data member in the C structure corresponds to a data block in the hardware design. If arrays are utilized, the programmer specifies the data width and/or array depth via C structure. In general, if functions employ large data structures as input arguments, the relevant data members should be added to xmem.

Furthermore, the system configuration is also defined by programmers, encompassing aspects such as the memory hierarchy, the number of RISC cores, and other system parameters.

In some embodiments, based on the necessary configuration information, the HLS tool is employed to generate the required accelerators based on the HLS function code. Moreover, the xmem generation tool generates RTL code for xmem, utilizing the xmem data structure defined in the C code. Additionally, the system generation tool instantiates all other memory blocks, including L1 and L2 memory, a DDR controller, and at least one RTL-coded RISC core. These components are interconnected according to the predefined system configuration.

In some embodiments, to ensure accurate system performance, a simulator is generated to provide a cycle-accurate representation, verify functional behaviour and benchmark performance, ensuring test coverage, performance, cost, and power are met.

Finally, in the last phase, the digital circuit is generated in the form of FPGA bitstreams or ASIC netlists, depending on the target platform. In case using FPGA as target, the hardware performance can be evaluated for further optimization in a new design iteration.

### Example 2

Heterogeneous Architecture System with Shared Accelerator Pool and Many-Ported Memory Subsystem (Xmem)

In some embodiments, provided is a heterogeneous multi-core architecture system that integrates various types of processing components, each optimized for specific tasks, allowing for a more efficient execution of diverse workloads. In some embodiments, the structure and composition of these components can be configured according to application requirements, leading to enhanced performance and flexibility in processing.

In some embodiments, the heterogeneous architecture system (also referred to as “heterogeneous functional architecture system” or “functional processor” in some embodiments) includes the following components:

### Processing Units

In some embodiments, the heterogeneous architecture system includes one or more processing units. Each of the processing unit includes a processing core. In some embodiments, one or more of the processing cores are Reduced Instruction Set Computer (RISC) cores, vector processing cores or any other type of processing cores. While the RISC cores are more suitable for general purpose computing, the vector cores are applied in some embodiments for data-parallel processing such as neural network, signal processing or graphics processing.

In some embodiments, one or more of the processing cores are data processing cores to support efficient data storage and transfer within the heterogeneous architecture system. Examples of data processing cores include, but are not limited to, Direct Memory Access (DMA) controllers, Level 2 (L2) caches, and external memory controllers.

In some embodiments, each processing core is configured to implement a virtualized function interface (referred to as “processing core function interface”), which enables a software interaction with one or more external accelerator cores as if calling a software function without considering the details of the application specific implementation. In some embodiments, the processing core function interface includes a processing core parent interface and a processing core child interface. In some embodiments, each processing core is also configured to implement the following modules and interfaces: shadow argument register file and inter-call interrupt handler. In some embodiments, each processing unit further includes at least one memory request port (also referred to as “xmem request port”) connected to the processing core. Details of these components will be discussed herein.

### Accelerator Units

In some embodiments, the heterogeneous architecture system further includes one or more accelerator units. Each of the accelerator unit includes an accelerator core (also referred to as “accelerator” in some embodiments). In some embodiments, one or more of the accelerator cores are fixed-function accelerators and/or reconfigurable logic blocks, such as embedded Field Programmable Gate Arrays (FPGAs) or Coarse-Grained Reconfigurable Arrays (CGRAs):
a. Fixed-Function Accelerators: These specialized components are designed for specific data processing tasks demanding high performance while consuming minimal power, such as AI, 5G communication or always-on computing.
b. Reconfigurable Logic Blocks (FPGAs and CGRAs): These blocks offer the flexibility to adapt to various tasks through reconfiguration. They can be reprogrammed to change the reconfigurable logic at run time. Though the reconfigurable time is longer than software programming, it is ideal for tasks like processing complex state machines or low latency processing.

In some embodiments, each accelerator core is configured to implement a virtualized accelerator interface (also referred to as “accelerator core function interface”) to interact with other processing cores or accelerator cores within the system. In some embodiments, the accelerator core function interface includes an accelerator core child interface and optionally an accelerator core parent interface. In some embodiments, each accelerator unit further includes at least one memory request port (also referred to as “xmem request port”) connected to the accelerator core. Details of these components will be discussed herein.

### Function Arbiters

In some embodiments, the heterogeneous architecture system further includes one or more function arbiters. Each function arbiter interacts with the one or more accelerator cores via the respective accelerator core function interfaces and the one or more processing cores via the respective processing core function interfaces. In some embodiments, the function arbiter is configured to facilitate and manage 4 types of function calls between different types of callers and callees: (i) calling from a processing core to another processing core; (ii) calling from a processing core to an accelerator core; (iii) calling from an accelerator core to another accelerator core; and (iv) calling from an accelerator core to a processing core. Each processing core or each accelerator core operates as a parent module (also referred to as “caller” or “caller module”) when sending a function call request to a child module (also referred to as “callee” or “callee module”) to execute a function, wherein the child module is a designated processing unit or a designated accelerator unit of the function call request, wherein the designated processing unit or the designated accelerator unit is not the processing unit or the accelerator unit operating as the parent module.

In some embodiments, the function arbiter includes a call arbiter and a return arbiter. The call arbiter is configured to forward function call requests from the parent interface of one or more of the parent modules to the child interface of one or more of the child modules. In some embodiments, the call arbiter is configured to receive the function call requests from one or more of the parent modules, arbitrate contentions among the function call requests, and forward the arbitrated function call requests to one or more of the child modules.

The return arbiter is configured to forward function return requests from multiple child interfaces of the child modules to multiple parent interfaces of the parent modules. In some embodiments, the return arbiter is configured to receive the function return requests from one or more of the child modules after one or more of the child modules finish executing the functions, arbitrate contentions among the function return requests, and forward the arbitrated function return requests to one or more of the parent modules.

Memory Subsystem (xmem)

In some embodiments, xmem is a configurable, multiple banks memory subsystem providing many memory ports to enable concurrent access to the many embedded cache and/or memory banks. In some embodiments, the memory subsystem (xmem) is composed of multiple memory groups, wherein each memory group contains a different number of memory banks of the same type. Each group of memory banks is implemented using various types of memory blocks that vary in terms of storage capacity, data width, and the number of read/write ports. Some memory types can further support selective access of some bytes of each word. Additionally, the number of memory banks in each memory group can be configured according to specific requirements.

In some embodiments, each memory port is connected with a dedicated request concentrator, which have multiple input ports connected with multiple memory request ports from the accelerator cores and/or the output ports of a memory switch to be connected with one or more processing cores and/or accelerator cores.

### Custom Glue Logic

In some embodiments, the heterogeneous architecture system further includes a custom glue logic configured to connect the memory request ports from multiple accelerator cores to multiple request concentrator inputs of the memory subsystem. The toolchain determines the actual implementation by analyzing the access patterns of each accelerator core.

### Memory Switch

In some embodiments, the heterogeneous architecture system further includes a memory switch configured to coordinate communication between the memory subsystem and the processing units and/or the accelerator units. The memory switch includes an access arbiter and a read-data arbiter. Both arbiters can either be implemented as a bus, crossbar or on-chip router.

### Example Heterogeneous Architecture System

Referring now to FIG. 1, which illustrates an example embodiment of a heterogeneous architecture system 1000. In this embodiment, the heterogeneous architecture system 1000 includes a RISC core 1010, xmem 1030, a function arbiter 1020 and three accelerator cores 1041, 1042 and 1043. The RISC core 1010 and the three accelerator cores 1041, 1042 and 1043 connect with xmem 1030 via one or more bus or switch (not shown) to exchange data. The RISC core 1010 communicates with the accelerator cores 1041, 1042 and 1043 via the function abiter1020. In some embodiments, the RISC core is configured to implement a RISC core function interface (not shown), and each of the accelerator cores 1041, 1042 and 1043 is configured to implement an accelerator core function interface (not shown) to interact with the RISC core function interface of the RISC core 1010 via the function arbiter 1020. Such configurations create a scalable network to enable data sharing among the RISC core 1010 and the accelerator cores 1041, 1042 and 1043 via xmem 1030.

### Memory Subsystem (XMEM)

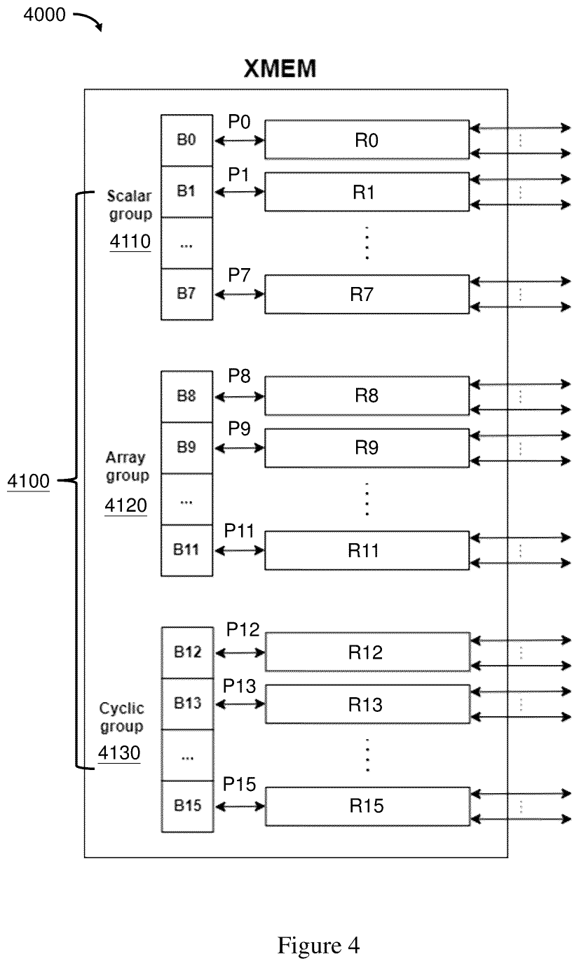

Referring now to FIG. 4, which shows the internal architecture of a memory subsystem XMEM 4000. In this embodiment, XMEM 4000 includes three memory groups 4100, namely scalar group 4110, array group 4120, and cyclic group 4130. Each memory group contains a different number of memory banks of the same type, and each group of memory banks is implemented using various types of memory blocks that vary in terms of storage capacity, data width, and the number of read/write ports, each tailored to specific storage and speed requirements to accommodate different accelerator needs. Additionally, the number of memory banks in each memory group can be configured according to specific requirements. In this embodiment, the scalar group 4110 contains 8 memory banks B0-B7, which are scalar memory/cache banks. The array group 4120 contains 4 memory banks B8-B11, which are register arrays. The cyclic group 4130 contains 4 memory banks B12-B15, which are cyclic memory/cache banks.

The XMEM 4000 further includes a plurality of memory ports P0-P15 (shown as arrows) and a plurality of request concentrators R0-R15. Each memory port is configured to connect a memory bank with a dedicated request concentrator. For example, memory port P7 is configured to connect memory bank B7 with request concentrator R7. Each of the request concentrators includes multiple input ports that connect to one or more processing cores and/or accelerator cores, for example via multiple memory request ports from the accelerator cores and/or the output ports of a memory switch (not shown), thereby enhancing the efficiency of data requests and responses.

In some embodiments, if the memory block is implemented as a cache, it has an interface to the next level memory (not shown) for writing back dirty lines and refilling missing lines.

### Memory Groups

In some embodiments, the memory banks in each type of memory group may have different number of access ports, data width, storage capacity and read/write latencies. Some examples include:
1. Register Files: Register files are small, fast memory blocks that allow for rapid data access with low latencies and high throughput for critical tasks. They support read and write operations for different data sizes: byte, halfword, and word, etc., as indicated below:
   a. Word (32-bit) Access: Read/Write: A 32-bit word can be read or written at any byte address that is aligned to a 4-byte (32-bit) boundary. This means that the least significant two bits of the address must be 0.
   b. Half-word (16-bit) Access: Aead/Write: A 16-bit half-word can be read or written at any byte address that is aligned to a 2-byte (16-bit) boundary. This means that the least significant bit of the address must be 0.
   c. byte (8-bit) Access: Read/Write: An 8-bit byte can be read or written at any byte address, without any specific alignment constraints.
2. Scalar Memory/Cache: This refers to a memory block with a one-word data width. This type of memory is designed to handle larger data sets efficiently while maintaining a fixed width for each access.
3. Vector memory/cache is specifically designed for vector processing cores, where each memory bank can be accessed independently via a crossbar switch using unique addresses. This architecture automatically resolves conflicts when multiple memory requests target the same memory bank by serializing access to that memory bank.
4. Cyclic Memory/Cache: Cyclic memory or cache allows for unaligned wide memory access, supporting variable numbers of consecutive words accessed through consecutive memory addresses. The number of words accessed can range from 1 to a configurable maximum width (MAX_WIDTH). If cost or power efficiency is an important consideration, this type of memory may be used to support simple data parallel operation which requires less complex memory operation than vector cache/memory.

### Connections Between Xmem, Processing Cores and Accelerator Cores

In some embodiments, xmem is configured to connect with the processing cores and accelerator cores in the heterogeneous architecture system to enable fast data exchange between the processing cores and the accelerator cores, as well as between accelerator cores.

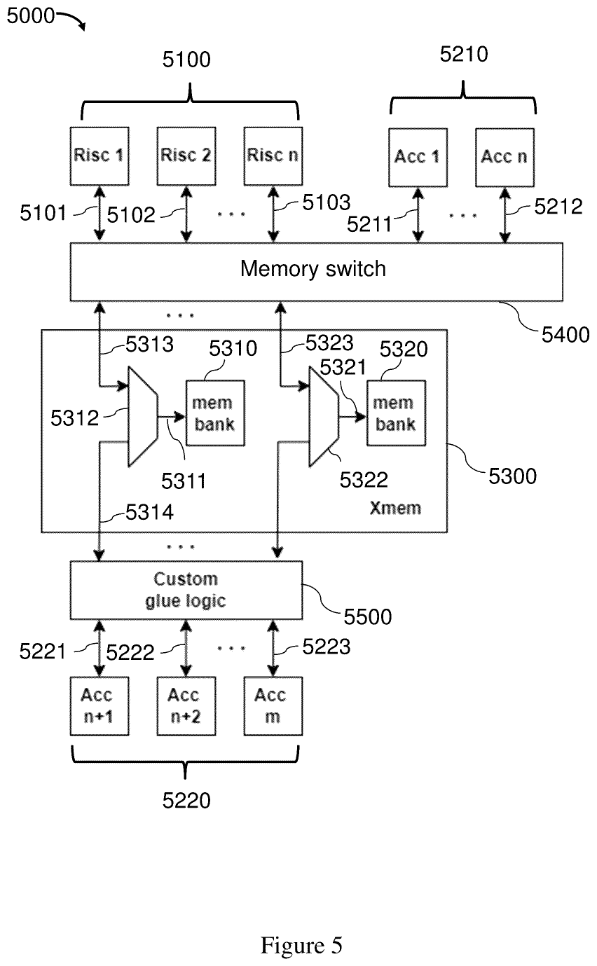

Referring now to FIG. 5, which shows the connections among accelerator cores, processing cores and xmem in a heterogeneous architecture system 5000. In this embodiment, the heterogeneous architecture system 5000 includes: a plurality of processing cores 5100 (processing cores Risc 1, Risc 2 to Risc n); a first set of accelerator cores 5210, (accelerator cores Acc 1 to Acc n); a second set of accelerator cores 5220 (accelerator cores Acc n+1, Acc n+2 to Acc m); a memory subsystem xmem 5300; a memory switch 5400; and a custom glue logic 5500.

Xmem 5300 contains a plurality of memory banks, including memory bank 5310 and memory bank 5320, which are connected to request concentrator 5312 and request concentrator 5322 respectively via their respective memory ports 5311 and 5321.

Memory switch 5400 is configured to coordinate communication of xmem 5300 with the processing cores 5100 and the first set of accelerator cores 5210, such that both the processing cores 5100 and the first set of accelerator cores 5210 can access the memory banks concurrently for efficient data access. The memory switch 5400 has an access arbiter and a read-data arbiter (not shown). Both the access arbiter and the read-data arbiter can either be implemented as a bus, crossbar or on-chip router.

The input ports of the access arbiter of the memory switch 5400 connect with multiple memory request ports of different processing cores (such as memory request port 5101 of Risc 1, memory request port 5102 of Risc 2, memory request port 5103 of Risc n, etc.) and memory request ports of the first set of accelerator cores 5210 (such as memory request port 5211 of Acc 1, memory request port 5212 of Acc n, etc.), while its output ports connect with different input ports of xmem request concentrators (such as input port 5313 of request concentrator 5312 and input port 5323 of request concentrator 5322). The access arbiter is configured to forward memory requests of the processing cores 5100 and/or the first set of accelerator cores 5210 to the plurality of request concentrators. Each input port of the access arbiter further contains an address decoder (not shown) which decodes the destined output ports and bank address to access different memory banks.

The read-data arbiter of the memory switch 5400 is configured to forward read data retrieved from the memory banks (such as memory banks 5310 and 5320) to the memory request ports of the processing cores 5100 and/or the first set of accelerator cores 5210 in response to the memory requests from the processing cores 5100 and/or the first set of accelerator cores 5210, if the memory requests are read requests.

In some embodiments, each accelerator core may have a variable number of memory request ports (also referred to as “xmem ports”), which may be zero, one or multiple ports. In this embodiment, custom glue logic 5500 is configured to connect individual memory request port of the second set of accelerator core 5220 (such as memory request ports 5221, 5222 or 5223 of accelerator cores Acc n+1, Acc n+2 or Acc m respectively) with one of the request concentrators of xmem 5300, such that the individual memory request port has a custom, static connection and buffers to connect with the memory port connected with one of the request concentrators, which in turn connect with one memory bank associated with a particular memory group. For example, the custom glue logic 5500 may connect the memory request port 5221 of accelerator core Acc n+1 with the input port 5314 of the request concentrator 5312, such that the memory request port 5221 has a custom connection with the memory bank 5310 which are linked with the request concentrator 5312. For each specific application, a toolchain can generate the custom glue logic by analyzing the connection requirement of between accelerator cores and xmem. By configuring and connecting the appropriate xmem memory banks based on the requirements of the accelerator cores and the storage capacity needed, the heterogeneous architecture system ensures highspeed data access and exchange among processing cores and accelerator cores.

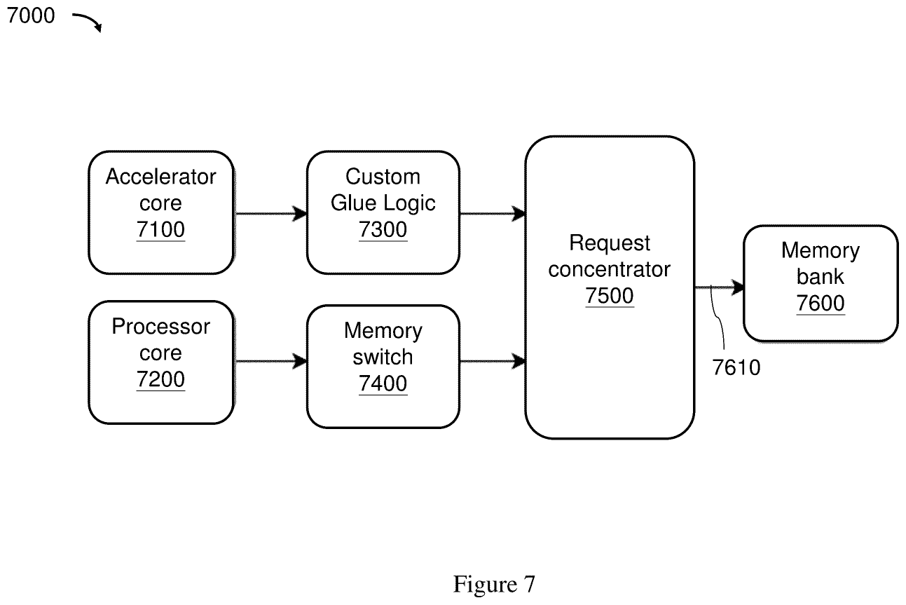

FIG. 7 is a diagram 7000 showing the connections between a processing core 7200, an accelerator core 7100 and a request concentrator 7500 for access of data in a memory bank 7600 according to an example embodiment. After the accelerator core 7100 is activated, for example by a function arbiter (not shown), its memory request port sends a memory read/write request via the custom-glue logic 7300 to the request concentrator 7500 connected to the destined memory bank 7600 via a memory port 7610. Meanwhile, the processing core 7200 may connect with any memory ports, including the memory port 7610 via request concentrator 7500. If the processing core 7200 needs to read/write data in the memory bank 7600, it first sends a memory request to the address decoder (not shown) of the memory switch 7400 connected to the processing core 7200 to determine the destined memory bank. Then it forwards the memory request to an attached input port of the memory switch 7400. After resolving the potential conflicts in accessing the memory bank 7600, the memory switch 7400 forward the memory request to the destined memory bank 7600.

### Accessing Xmem Data Blocks Via Request Concentrators

Referring now to FIG. 2, which shows an example diagram 2000 of how a RISC core 2001, a DMA controller 2004 and two accelerator cores Acc #1 2002 and Acc #2 2003 access a xmem 2100 consisted of 2 data blocks, namely xmem data block #1 2110 and xmem data block #2 2120 via 3 request concentrators. In this example, xmem data block #1 2110 is a dual ported RAM connected with two request concentrators Arb #1 2111 and Arb #2 2112 via memory ports 2113 and 2114 respectively, and xmem data block #2 2120 is a single-ported RAM connected with one request concentrator Arb #3 2121 via memory port 2122. In this example, DMA controller 2004 is connected to xmem 2100 and a Double Data Rate (DDR) controller 2005 so it can prefetch DDR data to be used by the RISC core 2001 and the accelerator core Acc #2 2003.

In this example, a request concentrator is attached to each memory port. Each memory port is “oversubscribed,” meaning that it connects to multiple memory request ports from different accelerator cores and/or processing cores through a request concentrator. For example, memory port 2113 connects to RISC core 2001 and accelerator core Acc #1 2002 through request concentrator 2111; memory port 2114 connects to RISC core 2001, accelerator core Acc #1 2002 and accelerator core Acc #2 2003 through request concentrator 2112; memory port 2122 connects to RISC core 2001, accelerator core Acc #2 2003 and DMA controller 2004 through request concentrator 2121. This design allows for efficient resource utilization, as it enables several accelerator cores and/or processing cores to share a single memory port. By ensuring that typically only one memory request is active at a time, the request concentrator aims to maximize memory port utilization while contention for memory access.

In some embodiments, when the processing core or the accelerator core sends a memory read or write request to a request concentrator, it sets the request enable bit of the corresponding input port of the request concentrator to ‘1’. The request concentrator monitors these request enable bits of all input ports. If it detects that one of these bits is set to ‘1’, it forwards the associated memory read or write request to the designated memory port. In cases where multiple memory request ports set their request enable bits to ‘1’, the request concentrator is configured to perform some form of arbitration, such as priority-based selection, round-robin scheduling, or random selection, to determine which request to process first. The chosen arbitration method ensures that only one request is forwarded to the memory port at one time, preventing conflicts and ensuring orderly access to the memory resources. The input ports which access are not granted will continue to request in subsequent cycles.

In some embodiments, after the request concentrator selects a valid request from one of the input ports, it accesses the locally attached memory to read or write data. If the request is to read data from the memory, the request concentrator either returns the read result (i.e. the data) to the required accelerator core via the custom glue logic or sends the read result to the requesting processing core via the memory switch. In some embodiments, each request concentrator has multiple input ports to receive memory requests from accelerator cores via the custom glue logic and one input port to receive a memory request from an output port of the memory switch.

### Memory Request Ports/Xmem Ports

In some embodiments, both the processing core and the accelerator core access xmem via a standardized memory request port (also referred to as “xmem port”) interface. In some embodiments, each xmem port is configured to send at least one of the following signals:
Request: send from the requester
Acknowledge: send from the xmem
Read-enable: send from the requester
Write-enable: send from the requester
Address: the byte address pointing at one of the memory bank in the xmem
Data length: the number of bytes to be accessed if used by cyclic cache
Write-data: the data to be written from the requester to the xmem
Read-data: the data to be read from the xmem to the requester

In some embodiments, each xmem port has an acknowledgement register bit allocated to it. The acknowledgement register bits of all valid xmem ports are reset to ‘0’ when calling a function. If a xmem access is granted, the acknowledgement bit is set to ‘1’. The request concentrator will ignore those input ports with the acknowledgement bit set to ‘1’.

In some embodiments, the acknowledgement register bit keep track of the fetched argument to prevent duplicated fetching. For example, a function may have 2 xmem arguments to be fetched from the same memory bank. Each argument has to be fetched one by one and so the fetched argument will set the acknowledgement register bit accordingly.

### Address Decoding Scheme

In some embodiments, memory in the memory subsystem xmem is organized into memory groups based on memory type, with each memory group assigned a distinct range of memory addresses (global address range). An address decoding scheme is utilized to decode the destined memory banks and memory words to be accessed by comparing the input global address with the global address range assigned to each memory group. In some embodiments, the address decoding scheme determines connections between request concentrators and processing cores/accelerator cores.

Dynamic connections: In some embodiments, the processing cores (such as RISC cores or DMA cores) and one or more accelerator cores are configured to connect dynamically to any memory port and its associated request concentrator via memory switches or buses. During runtime, the processing code utilizes the address decoding scheme to identify the appropriate destination memory port for data access.

Static connections: In some embodiments, the input port of each request concentrator has static connections to memory request ports of different accelerator cores to minimize latency and design complexity. In some embodiments, the toolchain determines which memory request ports of the accelerators to be connected with each request concentrator using the same decoding scheme with the following steps executed in compile time:
(i) analyzing source code to determine the address range in the memory subsystem as requested by each memory request port of each accelerator unit.
(ii) decoding the destined memory bank associated with the address range using the address decoding scheme
(iii) assigning a static connection between the accelerator port and one of the input ports of the request concentrator attached to the memory port of the destined memory bank when generating the heterogeneous architecture system.

In some embodiments, the address of the memory subsystem (global address) is mapped to a local memory address (xmem address), from xmem_start to xmem_start+xmem_size, where xmem_start corresponds for the first word in xmem and xmem_size is the aggregate address range of all xmem memory banks. Each memory group is assigned a non-overlapping sub-range (global address range) within the xmem range.

In some embodiments, each memory bank comprises a plurality of memory words. Each memory word of a memory bank is associated with a distinct global address and is accessed with a distinct bank address, each memory bank is assigned with a distinct bank index, and each memory group is assigned with a distinct global address range covering the global addresses of all memory words of the memory banks within the memory group.

In some embodiments, if a memory bank is cache, the total storage size of the group may be equal or greater its address range, depending on on run-time configuration by software. If the requested data is not cached in the memory group, the cache controller can fetch the missed data from the next-level cache or system memory. In some embodiments, each memory bank in the cached memory group includes a unique cache controller in order to enable concurrent cache accesses at different memory banks.

In some embodiments, the address decoding scheme of each memory group depends on its distinct configurations, including the global address ranges and the numbers of banks. In some embodiments, the address decoder decodes the input global address into the bank group, the bank index and the bank address in the two steps, i.e. range matching and bank mapping.

Firstly, upon receiving an input global address, for example in a memory request made by a processing core or an accelerator core, the range matching process compares the input global address against the starting and ending addresses of the global address ranges of each memory group to determine which target memory group the input global address is associated with. While the storage capacity is fixed at run time, the processing core can configure different address ranges for cached group at run time to map to different ranges of the system memory.

Secondly, the bank mapping scheme determines how to access one of the memory banks within the target memory group. To facilitate simultaneous access from different cores, the scheme should optimize the mapping of various input addresses to unique memory banks as much as possible. In some embodiments, a subset of the address bits of the input global address determines the memory bank within the target memory group while another subset of the address bits of the input global address determines the address of a memory word within the memory bank. In some embodiments, the address bits of the input global address can be divided into three non-overlapping segments of consecutive bits, specifically shown as below:
Least Significant Segment: This segment comprises the least significant bits of the address
Most Significant Segment: This segment includes the most significant bits of the address
Middle Segment: This segment consists of the bits that are neither included in the least significant segment nor in the most significant segment.

Each memory group may use a different bank mapping to decode bank index and bank address.

In some embodiments, if the memory group includes register-file banks, the least significant segment determines the bank indexes while the middle segment determines the bank address. A function usually accesses multiple consecutive data members of a structure which should be mapped to different register banks for optimum performance.

In some embodiments, if the memory group includes scalar/vector/cyclic cache banks, the middle segment determines the bank index while the least segment determines the bank address. In some embodiments, it is impossible to use least significant bits to select cache banks since this will map different words of a cache line to different banks, conflicting the requirement that each word of a line should map to the same cache bank.

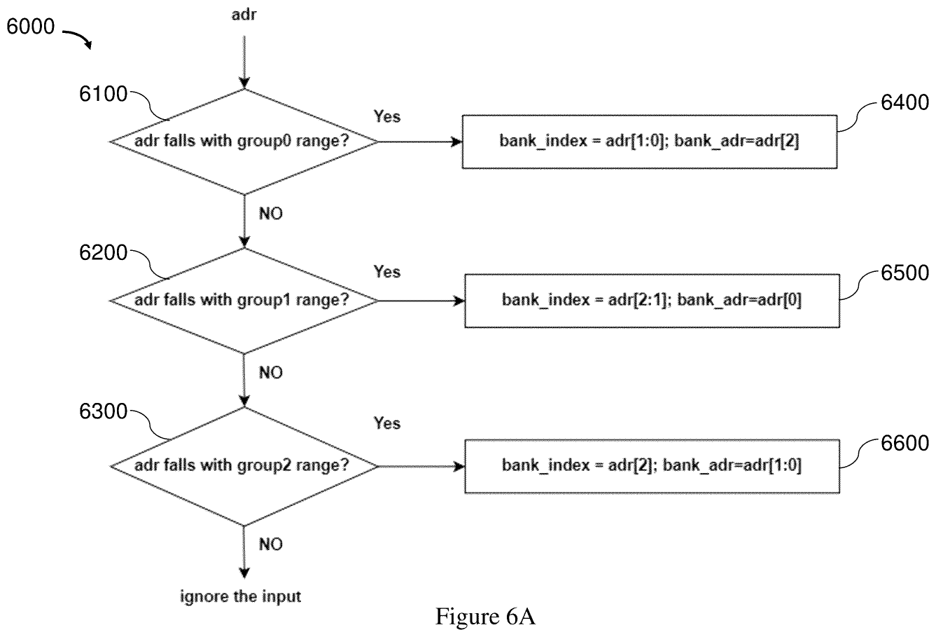

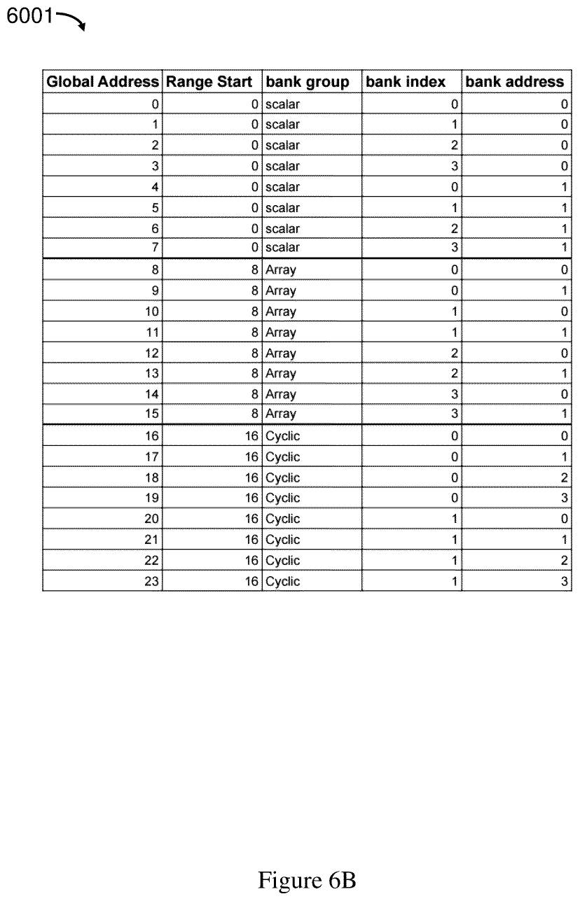

FIG. 6A illustrates a process 6000 of the address decoding scheme (the scheme) for accessing xmem. In this example, the xmem includes at least 3 memory groups, namely group0, group1 and group2. Process 6000 starts at 6100 with an input global address (adr) of an associated target memory word within a target memory bank in xmem that a processing core or an accelerator core requests to access.

In one embodiment, at 6100, the scheme evaluates whether the input global address (adr) falls within the global address range of the memory group0 (group0 range). If yes, at 6400, the scheme decodes the bank index by the first two least significant bits of adr, i.e. adr [1:0], and the bank address by the third least significant bit of adr, i.e. adr [2] to identify the target memory bank and the location of the target memory word respectively.

If adr does not fall within group0 range at 6100, the scheme further evaluates whether adr falls within the global address range of the memory group1 (group1 range) at 6200. If yes, at 6500, the scheme decodes the bank index by the second and third least significant bits of adr, i.e. adr [2:1], and the bank address by the first least significant bit of adr, i.e. adr [0] to identify the target memory bank and the location of the target memory word respectively.

If adr does not fall within group1 range at 6200, the scheme further evaluates whether adr falls within the global address range of the memory group2 (group2 range) at 6300. If yes, at 6600, the scheme decodes the bank index by the third least significant bit of adr, i.e. adr [2], and the bank address by the first two least significant bits of adr, i.e. adr [1:0] to identify the target memory bank and the location of the target memory word respectively.

If adr does not fall within group2 range at 6300, the scheme ignores the adr input.

FIG. 6B shows a table 6001 of how to map global address of each memory word to the bank group, the bank index and the bank address in the xmem bank layout according to the example embodiment of FIG. 6A. In this embodiment, the memory banks belonging to group0 store scalar words, and group0 has a global address range from 0 to 7. Each scalar word's bank index and bank address in group0 are configured to be decoded from the address bits of its global address (in binary form) according to the decoding scheme block 6400 shown in FIG. 6A.

The memory banks belonging to group1 store array words, and group1 has a global address range from 8 to 15. Each array word's bank index and bank address in group1 are configured to be decoded from the address bits of its global address (in binary form) according to the decoding scheme block 6500 shown in FIG. 6A.

The memory banks belonging to group2 store cyclic words, and group2 has a global address range from 16 to 23. Each cyclic word's bank index and bank address in group2 are configured to be decoded from the address bits of its global address (in binary form) according to the decoding scheme block 6600 shown in FIG. 6A.

By referring to both FIGS. 6A and 6B, considering now an example in which the global address of each memory word consists of 8 bits, and the input global address (adr) to access a target memory word is 3. As such, the corresponding address bits of the input global address will be 00000011. At 6100, the scheme determines that the adr (i.e. 3) falls within the global address range of the memory group0 (i.e. 0-7). At 6400, the scheme decodes the bank index by the first two least significant bits of the address bits of adr (i.e. 11) to obtain the bank index of 3. The scheme also decodes the bank address by the third least significant bit of the address bits of adr (i.e. 0) to obtain the bank address of 0. Hence, by using the address decoding scheme, the target memory word is accessible with the global address of 3, bank index of 3 and bank address of 0, consistent with the table 6001 in FIG. 6B.

### Function Arbiter

In some embodiments, the function arbiter of the heterogeneous architecture system includes a call arbiter and a return arbiter, which operate in parallel to handle multiple function call requests and multiple function return requests simultaneously. The call arbiter receives function call requests from parent modules, arbitrates contentions among the function call requests, and forwards the arbitrated requests to the child modules upon resolving call contentions, i.e. multiple parent modules send function call requests to the same child module. Meanwhile, the call arbiter may optionally contain one or more task queues to buffer the function call requests blocked by contentions during arbitration. After the child modules finish executing functions, the return arbiter receives function return requests from the child modules, arbitrate contentions among the function return requests, and forwards the arbitrated request to the calling parent module upon resolving return contentions, i.e. multiple child modules return results to the same parent module. Meanwhile, the return arbiter may optionally contain one or more result queues to buffer the function return requests blocked by contentions during arbitration.

In some embodiments, the call arbiter receives call commands from all processing units and a subset of accelerators which will call child functions. The call arbiter sends a return-request flag from one of the caller modules to the destined callee module. If the return-request flag is ‘1’, the callee module sends the return result to the return arbiter after executing its function. The call arbiter ensures that each callee can only receive call requests from one caller module at a time while the return arbiter ensures that each caller only receives return results from one of the callee modules at a time.

### Virtual Function Call Process

In some embodiments, in a heterogeneous architecture system, all processing cores have shared access to a pool of accelerator cores, thus maximizing the utilization of these specialized resources to aggregate throughput. Each processing core/accelerator core can request another processing core/accelerator core to execute a function. Within this framework, if a processing core/accelerator core operates as a parent module (also referred to as “caller module”), it can send a function call request to another processing core/accelerator core, operates as a child module (also referred to as “callee module”). Each processing core can operate as a caller module or callee module based on runtime conditions. All accelerators must operate as a callee module while a subset of the accelerators can also dynamically operate as a caller module if it can also send a function call request.

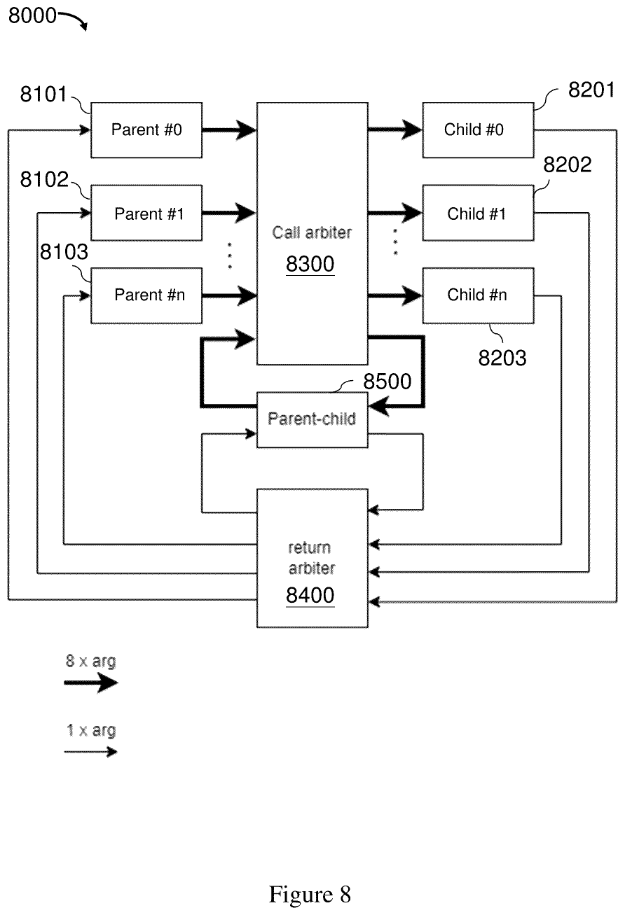

FIG. 8 is a diagram 8000 showing the connections among a plurality of parent modules (parent modules Parent #0 8101, Parent #1 8102 to Parent #n 8103), a plurality of child modules (child modules Child #0 8201, Child #1 8202 to Child #n 8203), a parent-child module 8500, a call arbiter 8300 and a return arbiter 8400 in an example heterogeneous architecture system.

In some embodiments, the function arbiter, which includes the call arbiter 8300 and the return arbiter 8400, is configured to facilitate and manage 4 types of function calls between different types of callers and callees:
(i) calling from a processing core to another processing core;
(ii) calling from a processing core to an accelerator core;
(iii) calling from an accelerator core to another accelerator core and
(iv) calling from an accelerator core to a processing core, denotes as an accelerator callback.

Each processing core or each accelerator core can operate as a parent module or a child module when interacting with the function arbiter. An example virtual function call operation includes at least the following steps.

### 1. One or Multiple Parent Modules Send Function Call Requests to the Call Arbiter.

In some embodiments, multiple parent modules, such as parent modules Parent #0 8101, Parent #1 8102 and Parent #n 8103, may simultaneously send function call requests to the call arbiter 8300.

In some embodiments, if the parent module is an accelerator core, it can directly output all function arguments via the accelerator core parent interface (not shown). In some embodiments, if the parent module is a processing core, it continuously copies the function arguments to a shadow argument register file before the function call and forwards the whole shadow argument register file to the processing core parent interface (not shown) when sending the function call requests.

2. The Call Arbiter Forwards the Function Call Requests from Parent Modules to Child Modules

In some embodiments, the call arbiter 8300 arbitrates function call requests sent from each parent module to each child module and forwards multiple function call requests after resolving contention, thus activating one or multiple child modules (such as child modules Child #0 8201, Child #1 8202, Child #n 8203) to serve the request. For example, both parent modules Parent #0 8101 and Parent #1 8102 may simultaneously send function call requests to one or more of the child modules via the call arbiter 8300. After resolving the contentions among these function call requests, the call arbiter 8300 forwards the successful function call requests (for example, the function call request from the parent module Parent #0 8101) to the targeted one or more child modules while buffering the unsuccessful ones (for example, the function call request from the parent module Parent #1 8101) for retrying the function call requests in subsequent cycles. In some embodiments, unless the arbiter buffers of the call arbiter are full, the parent modules can operate in a fire-and-forget manner.

In some embodiments, each function call request includes a child module index, i.e. the module index of the executing core of the designated child module, and up to N function arguments, where N is the maximum number of function arguments the parent module is able to send. In some embodiments, N is 8 in RISC-V architecture. If the child module is a processing core, the parent module should also provide a target program counter (PC) of the function to be executed by the target processing core.

3. The Child Module Execute a Function Upon Receiving a Function Call Request from the Call Arbiter

In some embodiments, upon receiving a function call request from the call arbiter, the child module accesses the following two types of function arguments to execute a function: (a) fetch input arguments from output buffers of the call arbiter, which are directly passed from the parent module to the call arbiter; and (b) based on memory pointers, fetch xmem arguments by reading input argument from xmem or output argument by writing to xmem. In some embodiments, the function call request contains a parent module index to identify the parent module that sends the function call request. When the child module receives a function call request, it has to store the parent module index and retrieve it later as the destination of the function return request.

In some embodiments, if the child module is an accelerator core, the accelerator core child interface is configured to: (i) fetch multiple arguments from the output buffer of the call arbiter; and (ii) keep track of whether return value is required and store the parent module index in a return-index buffer to identify the parent module that sends the function call request. In some embodiments, if the accelerator core has one or more memory request ports, the custom glue logic of the accelerators is configured to issue one or multiple memory requests during execution of the function.

In some embodiments, if the child module is a processing core, the execution pipeline of the processing core interrupts the current operation and saves the context information. The processing core child interface is configured to: (i) extract the target PC from the output buffer of the call arbiter; (ii) copy arguments from the output buffer of the call arbiter to the RISC general purpose registers one by one; and (iii) keep track of whether return value is required and store the parent module index in a return-index buffer to identify the parent module that sends the function call request. The processing core then starts executing the instructions starting from the target PC.

### 4. One or Multiple Child Modules Send Function Return Requests to the Return Arbiter.

In some embodiment, once each child module has completed executing the function, it sends a function return request to the parent module via the return arbiter 8400, as specified in the return index buffer. In some embodiments, if the child module is a processing core, it will also resume executing the thread before the function call request is handled by restoring the thread context and continuing to execute from the last interrupted PC.

5. The Return Arbiter Forwards the Function Return Requests from Child Modules to Parent Modules

In some embodiments, multiple child modules may simultaneously send function return requests to the return arbiter 8400. In such situation, the return arbiter is configured to arbitrate contentions among the function return requests sent from each child module to each parent module, and forward the function return requests after resolving contention. In some embodiments, the return arbiter forwards the successful return request and buffered the unsuccessful one for retry later.

6. The Parent Modules May or May not Wait for the Return Results from One or Multiple Child Modules, Depending on the Subsequent Operations of the Parent Modules

In some embodiments, after finishing executing the function, the child module may or may not need to send results back to the return arbiter, depending on the return-request flags from the parent modules. If the subsequent operation is independent of the return results, the parent module continues to execute other operations not depending on the return results. However, if the subsequent operation depends on the return results, and if the results are not ready, the parent module stalls its operations, effectively pausing its tasks until the return results are received from the return arbiter. If the results are ready, the parent module fetches the return results from the output buffers of the return arbiter, and then proceeds with executing the other operations.

In some embodiments, it is possible to have multi-level function calls among accelerator cores and processing cores by cascading call requests. For example, if accelerator A has a child accelerator B and accelerator B has a child accelerator C, then the function call and return sequences are:
(i). accelerator A calls accelerator B
(ii). accelerator B calls accelerator C
(iii). accelerator C returns the result to accelerator B
(iv). accelerator B returns the result to accelerator A.

Now referring to FIG. 8, where an example multi-level function call and return sequence among parent module Parent #0 8101, parent-child module 8500 and child module Child #0 8201 is illustrated. In this example, the accelerator core/processing core of the parent-child module 8500 operates as both a parent module and a child module. Firstly, the parent module Parent #0 8101 sends a first function call request to the call arbiter 8300, which forwards the first function call request to the parent-child module 8500. Upon receiving and executing the first function call request, the parent-child module 8500 sends a second function call request to the call arbiter 8300, which forwards the second function call request to the child module Child #0 8201. Upon receiving and executing the second function call request, the child module Child #0 8201 sends a first function return request and optionally the return results to the return arbiter 8400, which forwards the first function return request and optionally the return results to the parent-child module 8500. The parent-child module 8500 in turn sends a second function return request and optionally the return results to the return arbiter 8400, which forwards the second function return request and optionally the return results to the parent module Parent #0 8101, thus completing the multi-level function call and return sequence.

In some embodiments, it is also possible to support recurve call if the accelerator has sufficient stack memory for recursive operations.

### Accelerator Callback Operations

In some embodiments, function calls may be sent from an accelerator core to processing cores (e.g. RISC), which denotes as an accelerator callback, for handling one or more of the following cases: (i) large but infrequently-executed C function which is not cost-effective to be implemented in HLS; (ii) run in hypervisor or supervisor mode to access resource controlled by the operating system, such as peripherals or storage; and (iii) adding watch points to accelerator cores to trigger debugging function running in RISC.

In some embodiments, there are 2 RISC operations involved in handling callback from accelerator to RISC.
1. RISC-get-call: Hardware accelerators pass arguments, RISC index and PC to start RISC-V functions at a specific core;
2. RISC-send-return: Hardware accelerators to get RISC-V function returns value. In such operation, return FIFO queue is used for each function to handle out-of-order finish time.

In order to support ‘RISC-get-call’ operations, the RISC need to execute an inter-call handler function when receiving asynchronous activation from another caller module, similar to interrupt handling. In some embodiments, the RISC is configured to pause the existing software execution to execute the function required by any external accelerator. Upon finishing executing the interrupting function, the RISC is configured to resume execution from the last paused PC. In one of the embodiments, the following handler assumes that the PC has multiple register pages to support fast call handling:
Find a free register page p0 to run the interrupting function;
if there is no free register page, find any in-use register page p0 to be used by new interrupting function;
save the content of the current page to stack;
store pc0 and function arguments passed from external accelerators to a get-call buffer of the processing core;
copy at most 8 function arguments from the argument buffer to register a0-a7 of the page p0 and copy pc0 to the PC register associated with page p0-execute the function by jumping to the new pc0;
when finish executing the function, free the current register page p0.

### Virtualized Interface for Passing of Function Calls

In some embodiments, the processing core (e.g. RISC core) firmware treats each accelerator core as another RISC core running application specific functions independently, i.e. virtualizing different accelerator cores as different accelerator functional threads. The processing core function interface for each processing core is established to facilitate efficient passing of function arguments from the processing core to different accelerator cores. Furthermore, some function arguments may represent pointers to some xmem data members, thus effectively passing data structures without overhead.

In some embodiments, the use of the same processing core function interface in each processing core for interacting with different accelerator cores offers flexibility and modularity. By treating each accelerator core as a “function” (i.e. an “accelerator functional thread”) that can be invoked through a unified interface, the processing core simplifies the programming and control flow for utilizing various hardware accelerator cores.

Referring now to FIG. 3, which shows an example processing pipeline 3000 of a processing core in the heterogeneous architecture system. The processing pipeline 3000 comprises a fetch stage 3005, a decoder stage 3006, an execution stage 3007, a memory access stage 3008, a write-back stage 3009, a function arbiter 3001, and three hardware accelerator cores Acc #1 3002, Acc #2 3003 and Acc #3 3004. In this embodiment, each of the three hardware accelerator cores Acc #1 3002, Acc #2 3003 and Acc #3 3004 are encapsulated as an accelerator functional thread in the processing core.

When an instruction (e.g. a function call) comprising a target PC value is fetched at the fetch stage 3005, the processing core examines the target PC value and performs decoding operations at the decoder stage 3006 to determine whether the target PC value corresponds to one of the accelerator functional threads or a normal software function call. At the execution stage 3007, if it is a normal software function call, the processing core operates in the same manner as existing processors, following the established conventions. On the other hand, if the target PC matches one of the accelerator functional threads, for example the accelerator functional thread corresponding to the accelerator core Acc #1 3002, the processing core sends a function call request to activate the corresponding accelerator core Acc #1 3002 via the function arbiter 3001 and transmits the variable number arguments to the corresponding accelerator core Acc #1 3002 depending on the functions being called.. In some embodiments, the processing core includes a processing core call interface which performs one or more of the operations as described above.

In some embodiments, the processing core (e.g. RISC core) creates an accelerator functional thread in a blocking mode or a non-blocking mode. If using blocking mode, the processing core is configured to stall until the requested accelerator core completes its operation and it is ready to process a new request. If using non-blocking mode, the processing core continues executing the subsequent instructions, potentially fetching the accelerator core's result later when triggered by interrupt or mutex signalling. This mode allows for more concurrent and parallel execution within the functional processor. Meanwhile, a data member of the xmem used by the destined accelerator core will be locked by mutex mechanism and the accelerator core will free it later when it finishes execution the function.

In some embodiments, the non-blocking mode includes a task queue. If an accelerator core is busy when a function is called, the function arguments are pushed to a task queue and the destined functional accelerator core pops the argument later when it is free. To maximize efficiency, in some embodiments, the heterogeneous architecture system utilizes a memory block with a wide data path to store the function arguments. It can push multiple function arguments simultaneously, taking advantage of the parallelism provided by the wide data path. For example, assuming the width of the data path is W, indicating the number of arguments that can be accessed in one cycle. Consider a memory block with a wide data path that can push or pop W arguments in each cycle. Now, suppose there is a target functional accelerator core that requires N′ arguments. In a non-blocking mode, it would take N′/W cycles to pass all the required arguments to the accelerator core.

In some embodiments, regardless of the mode, the processing core function interface ensures software compatibility and transparency by utilizing the same software API for both software function calls and functional accelerator cores invocations. This approach promotes a seamless integration of accelerator cores into the system, allowing developers to leverage them without significant changes to their code. It can also ensure binary compatibility when reusing the same software for chips with no accelerator core or different accelerator cores with compatible arguments. By offering a unified interface and supporting different modes of operation, the heterogeneous architecture system provides a flexible and efficient approach to incorporating hardware accelerator cores into the overall system architecture.

### Method and Tool Chain to Design and Fabricate the Heterogeneous Architecture System

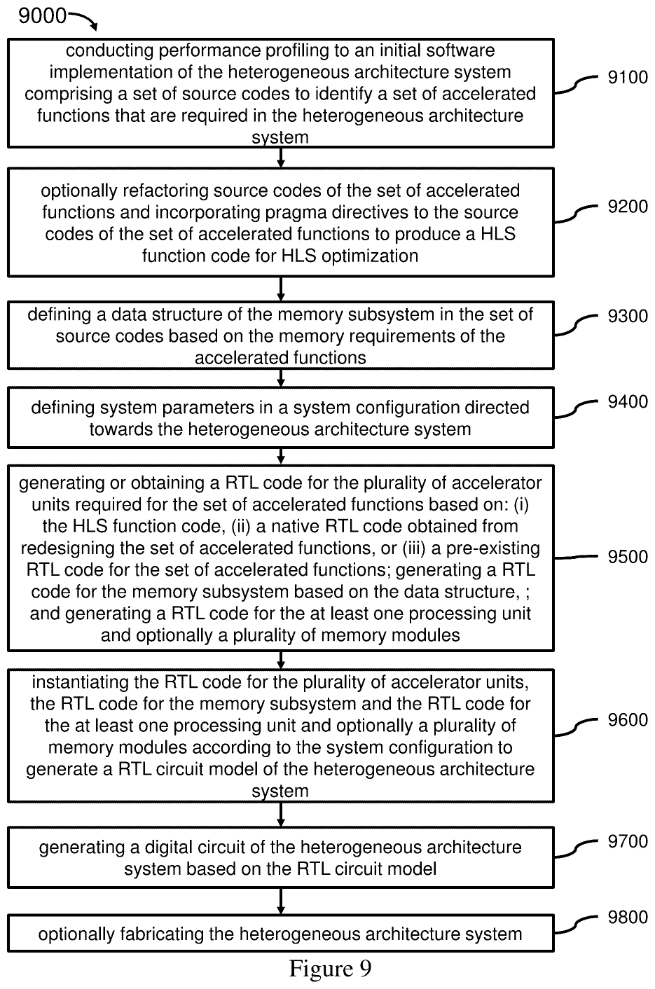

FIG. 9 is a flowchart 9000 of an example computer-implemented method to design and optionally fabricate a heterogeneous architecture system according to any of the examples as described herein. In some embodiments, one or more steps in the example method are performed by utilizing a functional synthesis tool chain, which includes multiple components such as a High-Level Synthesis (HLS) tool, a memory subsystem generation tool and a system generation tool.

Block 9100 states conducting performance profiling to an initial software implementation of the heterogeneous architecture system comprising a set of source codes to identify a set of accelerated functions that are required in the heterogeneous architecture system.

In some embodiments, the process commences with the programmer writing a set of source codes (e.g. C code), serving as the initial software implementation of the heterogeneous architecture system. Performance profiling is conducted to identify a set of functions that are required to be accelerated (i.e. the accelerated functions) in the heterogeneous architecture system.

Block 9200 states refactoring source codes of the set of accelerated functions and incorporating pragma directives to the source codes of the set of accelerated functions to produce a HLS function code for HLS optimization.

Block 9300 states defining a data structure of the memory subsystem in the set of source codes based on the requirements of the set of accelerated functions.

In some embodiments, the memory subsystem (xmem) is defined as a data structure in C code or any other programming language. In the xmem data structure, the xmem width and depth can be deduced from xmem related pragma, such as Xilinx HLS pragma of array partition. Each data member in the data structure (e.g. C structure) corresponds to a data block/memory block in the hardware design. In some embodiments, if arrays are utilized, the programmer specifies the data width and/or array depth via C structure. In some embodiments, if functions employ large data structures as input arguments, the relevant data members should be added to xmem.

In some embodiments, the tool chain generates a custom data block/memory block in hardware corresponding to each data member of the structure in the source code. Different design parameters of the data blocks can be configured depending on application-specific requirements. The configurable parameters of each data block include, but are not limited to: memory/storage type, memory depths and widths, number of read/write ports associated with the memory block, and connections with at least one of the accelerator units and/or at least one processing unit.

Block 9400 states defining system parameters in a system configuration directed towards the heterogeneous architecture system.

In some embodiments, the system configuration is defined by programmers, encompassing system parameters such as the memory hierarchy, the number of RISC cores, and other system parameters.

Block 9500 states generating or obtaining a RTL code for the plurality of accelerator units required for the set of accelerated functions based on: (i) the HLS function code, (ii) a native RTL code obtained from redesigning the set of accelerated functions, or (iii) a pre-existing RTL code for the set of accelerated functions; generating a RTL code for the memory subsystem based on the data structure; and generating a RTL code for the at least one processing unit and optionally a plurality of memory modules. For the sake of clarity, the “pre-existing RTL code” for the set of accelerated functions refers to an RTL code that has been previously developed for the specific accelerated functions, and available for reuse in a new system design to expedite the implementation of the set of accelerated functions.

In some embodiments, block 9500 is performed by the tool chain, which includes the HLS tool, the memory subsystem generation tool and the system generation tool. Based on the necessary system configuration information, the HLS tool is employed to generate the RTL code for the required accelerator units based on the HLS function code. Moreover, the memory subsystem (xmem) generation tool generates RTL code for xmem, utilizing the xmem data structure defined in the set of source codes (e.g. C code). Additionally, the system generation tool generates all other memory modules, including L1 and L2 memory, a DDR controller, and at least one RTL-coded processing core (e.g. RISC core), based on the necessary system configuration information.

Block 9600 states instantiating the RTL code for the plurality of accelerator units, the RTL code for the memory subsystem and the RTL code for the at least one processing unit and optionally a plurality of memory modules according to the system configuration to generate a RTL circuit model of the heterogeneous architecture system.

In some embodiments, the system generation tool of the tool chain instantiates the memory modules, the DDR controller, at least one RTL-coded processing core of the at least one processing unit, the plurality of accelerator cores of the accelerator units, and the memory subsystem. These components are interconnected according to the predefined system configuration to generate the RTL circuit model of the heterogeneous architecture system.

In some embodiments, the input port of each request concentrator in xmem has static connections to memory request ports of different accelerator cores to minimize latency and design complexity. In some embodiments, the tool chain determines which memory request port to be connected with each request concentrator with the following steps:
analyzing the set of source codes to determine an address range in the memory subsystem as requested by each memory request port of each accelerator unit;
decoding a destined memory bank associated with the address range using an address decoding scheme to identify the memory port coupled with the destined memory bank; and
assigning a static connection between the memory request port of the accelerator unit and one of the input ports of the request concentrator attached to the memory port of the destined memory bank when generating the RTL circuit model of the system.

In some embodiments, to ensure accurate system performance, a simulator is generated to provide a cycle-accurate representation, verify functional behaviour and benchmark performance, ensuring test coverage, performance, cost, and power are met.

Block 9700 states generating a digital circuit of the heterogeneous architecture system based on the RTL circuit model.

In some embodiments, the digital circuit is generated in the form of FPGA bitstreams or ASIC netlists, depending on the target platform. In case using FPGA as target, the hardware performance can be evaluated for further optimization in a new design iteration.

Block 9800 states optionally fabricating the heterogeneous architecture system.

In some embodiments, in an optional step, the RTL circuit model of the heterogeneous architecture system is passed to an integrated circuit fabrication machinery operable to fabricate hardware circuitry of the heterogeneous architecture system.

In some embodiments, a computer program product, loadable in the memory of at least one computer and including instructions which, when executed by the computer, cause the computer to perform a computer-implemented method to design and optionally fabricate a heterogeneous architecture system according to any of the examples as described herein.

The system and method of the present disclosure may be implemented in the form of a software application running on a computer system. Further, portions of the methods may be executed on one such computer system, while the other portions are executed on one or more other such computer systems. Examples of the computer system include a mainframe, personal computer, handheld computer, server, etc. The software application may be stored on a recording media locally accessible by the computer system and accessible via a hard wired or wireless connection to a network, for example, a local area network, or the Internet.

The computer system may include, for example, a processor, random access memory (RAM), a printer interface, a display unit, a local area network (LAN) data transmission controller, a LAN interface, a network controller, an internal bus, and one or more input devices, for example, a keyboard, mouse etc. The computer system can be connected to a data storage device.

In some embodiments, blocks and/or methods discussed herein can be executed and/or made by a user, a user agent (including machine learning agents and intelligent user agents), a software application, an electronic device, a computer, firmware, hardware, a process, a computer system, and/or an intelligent personal assistant. Furthermore, blocks and/or methods discussed herein can be executed automatically with or without instruction from a user.

It should be understood for those skilled in the art that the division between hardware and software is a conceptual division for ease of understanding and is somewhat arbitrary. Moreover, it will be appreciated that peripheral devices in one computer installation may be integrated to the host computer in another. Furthermore, the application software systems may be executed in a distributed computing environment. The software program and its related databases can be stored in a separate file server or database server and is transferred to the local host for execution. Those skilled in the art will appreciate that alternative embodiments can be adopted to implement the present invention.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

Methods discussed within different figures can be added to or exchanged with methods in other figures. Further, specific numerical data values (such as specific quantities, numbers, categories, etc.) or other specific information should be interpreted as illustrative for discussing example embodiments. Such specific information is not provided to limit example embodiment.

What is claimed is:

1. A heterogeneous architecture system comprising
a) at least one processing unit comprising a processing core, wherein the processing core is configured to implement a processing core function interface comprising a processing core child interface and a processing core parent interface;
b) a plurality of accelerator units each comprising an accelerator core, wherein the accelerator core is configured to implement an accelerator core function interface comprising an accelerator core child interface and optionally an accelerator core parent interface; and
c) at least one function arbiter connected to the at least one processing unit and the plurality of accelerator units,
wherein the at least one processing unit or one of the accelerator units operates as a parent module when sending a function call request to a child module to execute a function, wherein the child module is a designated processing unit or a designated accelerator unit;
wherein the at least one function arbiter is configured to:
forward one or more function call requests received from the processing core parent interface or from the accelerator core parent interface of one or more of the parent modules to the processing core child interface or to the accelerator core child interface of one or more of the child modules, and
optionally forward one or more function return requests received from the processing core child interface or from the accelerator core child interface of one or more of the child modules to the processing core parent interface or to the accelerator core parent interface of one or more of the parent modules.

2. The system of claim 1, wherein the at least one function arbiter comprises a call arbiter and a return arbiter,
wherein the call arbiter is configured to receive the function call requests from one or more of the parent modules, arbitrate contentions among the function call requests, and forward the arbitrated function call requests to one or more of the child modules, wherein the call arbiter optionally comprises one or more task queues to buffer the function call requests blocked by contentions;
wherein the return arbiter is configured to receive the function return requests from one or more of the child modules after one or more of the child modules finish executing the functions, arbitrate contentions among the function return requests, and forward the arbitrated function return requests to one or more of the parent modules, wherein the return arbiter optionally comprises one or more result queues to buffer the function return requests blocked by contentions.

3. The system of claim 1, wherein the processing core further comprises a general purpose register (GPR) file and a shadow argument register file, wherein the processing core is configured to continuously duplicate one or more argument registers from the GPR file to the shadow argument register file, and when the processing core is sending a function call request, the processing core is configured to forward the argument registers from the shadow argument register file to the processing core parent interface.

4. The system of claim 3, wherein the shadow argument register file and the GPR file have the same number of argument registers, and the shadow argument register file is configured to continuously monitor a write-back status of the one or more argument registers in the GPR file to ensure that the one or more argument registers in the shadow argument register file are synchronized with the one or more argument registers in the GPR file.

5. The system of claim 1, wherein each of the function call requests further comprises:
a child module index to identify the child module designated for the function call request;
up to N function arguments, wherein N is a maximum number of function arguments the parent module is able to send; and
a parent module index to identify the parent module that sends the function call request,
wherein the child module is configured to:
store the parent module index upon receiving the function call request; and
retrieve the parent module index as a destination of the function return request after executing a function requested by the function call request if a return result of executing the function is required by the parent module.

6. The system of claim 1, wherein if the child module of the function call request is the at least one processing unit, the function call request further comprises a target program counter (PC) value of the function to be executed by the processing core of the at least one processing unit, and the child module is further configured to:
interrupt an operation of the processing core and save an execution context of the operation;
extract the target PC value and function arguments from the call arbiter by the processing core child interface;
executing the function starting from the target PC value; and
restoring the execution context and resume executing the operation.

7. The system of claim 1, wherein if the child module of the function call request is one of the accelerator units, the child module is configured to:
fetch one or more function arguments from the call arbiter; and/or
fetch one or more function arguments from the memory subsystem by sending one or more memory requests to the memory subsystem.

8. The system of claim 1, wherein the accelerator core of each of the accelerator units is encapsulated as an accelerator functional thread in the processing core of the at least one processing unit, wherein the processing core is configured to:
determine whether a target PC value of an instruction matches a specific accelerator functional thread; and
if the target PC value matches the specific accelerator functional thread, send a function call request to the accelerator core corresponding to the specific accelerator functional thread.

9. The system of claim 1,
wherein the at least one processing unit further comprises at least one memory request port connected to the processing core;
wherein each of the accelerator units further comprises at least one memory request port connected to the accelerator core;
wherein the system further comprises a memory subsystem comprising:
a plurality of memory groups, wherein each memory group comprises a plurality of memory banks of a single memory type;
a plurality of memory ports, wherein each memory port is configured to connect with one of the memory banks;
a plurality of request concentrators, wherein each request concentrator is configured to connect one of the memory ports with at least one memory request port of the at least one processing unit and/or at least one memory request port of at least one of the accelerator units, such that the at least one processing unit and/or the at least one of the accelerator units can access the plurality of memory banks concurrently.

10. The system of claim 9,
wherein each of the memory banks comprises a plurality of memory words,
wherein each of the memory words is associated with a distinct global address, and each of the memory groups is assigned with a distinct global address range covering the global addresses of all memory words of the memory banks within the memory group,
wherein the system further comprises an address decoder, wherein upon receiving an input global address in a memory request made by the at least one processing unit and/or at least one of the accelerator units to access a target memory word in a target memory bank within a target memory group, the address decoder is configured to locate the target memory bank and the target memory word using an address decoding scheme comprising the following steps:
comparing the input global address against the global address range assigned to each of the memory groups to determine the target memory group that associates with the input global address;
and
decoding a bank index and a bank address from the input global address, wherein the bank index identifies the target memory bank within the target memory group and the bank address identifies the location of the target memory word within the target memory bank.

11. The system of claim 10, wherein the input global address comprises a set of address bits having a least significant segment, a most significant segment and a middle segment, and wherein the memory type of each of the memory groups is a register-file bank or a cache bank,
wherein if the memory type of the target memory group is the register-file bank, the least significant segment determines the bank index and the middle segment determines the bank address; and
if the memory type of the target memory group is the cache bank, the middle segment determines the bank index while the least significant segment determines the bank address.

12. The system of claim 9, wherein the plurality of request concentrators are connected with the at least one processing unit and the plurality of accelerator units via a static connection and/or a dynamic connection,
wherein one or more of the request concentrators connect with the at least one processing unit and one or more of the accelerator units by the dynamic connection configured with a memory switch at a run time; and
wherein one or more of the request concentrators connect with one or more of the accelerator units via the static connection.

13. A computer-implemented method to design and optionally fabricate a heterogeneous architecture system of claim 1, wherein the method comprises the following steps:
a) conducting performance profiling to an initial software implementation of the heterogeneous architecture system to identify a set of accelerated functions that are required in the heterogeneous architecture system, wherein the initial software implementation comprises a set of source codes;
b) optionally refactoring source codes of the set of accelerated functions and incorporating pragma directives to the source codes of the set of accelerated functions to produce a High-Level Synthesis (HLS) function code for HLS optimization;
c) defining a data structure of a memory subsystem in the set of source codes based on the requirements of the accelerated functions;
d) defining system parameters in a system configuration directed towards the heterogeneous architecture system;
e) generating or obtaining a Register Transfer Level (RTL) code for the plurality of accelerator units required for the set of accelerated functions based on: (i) the HLS function code, (ii) a native RTL code obtained from redesigning the set of accelerated functions, or (iii) a pre-existing RTL code for the set of accelerated functions; generating a RTL code for the memory subsystem based on the data structure; and generating a RTL code for the at least one processing unit and optionally a plurality of memory modules;
f) instantiating the RTL code for the plurality of accelerator units, the RTL code for the memory subsystem and the RTL code for the at least one processing unit and optionally a plurality of memory modules according to the system configuration to generate a RTL circuit model of the heterogeneous architecture system;
g) optionally generating at least one simulator software of the heterogeneous architecture system based on the RTL circuit model to assess the system performance;
h) generating a digital circuit of the heterogeneous architecture system based on the RTL circuit model; and
i) optionally fabricating the heterogeneous architecture system.

14. The computer-implemented method of claim 13, wherein one or more of steps (a)-(h) are performed using a tool chain comprising a HLS tool, a memory subsystem generation tool and a system generation tool,
wherein step (e) comprises the following steps:
e1) generating, by the HLS tool, the RTL code for the plurality of accelerator units;
e2) generating, by the memory subsystem generation tool, the RTL code for the memory subsystem; and
e3) generating, by the system generation tool, the RTL code for the at least one processing unit and optionally the plurality of memory modules;
wherein the instantiating step in step (f) is performed by the system generation tool.

15. The computer-implemented method of claim 13, wherein step (f) comprises the following steps:
f1) analyzing the set of source codes to determine an address range in the memory subsystem as requested by the at least one memory request port of individual accelerator unit;
f2) decoding a destined memory bank associated with the address range using an address decoding scheme to identify the memory port coupled with the destined memory bank;
f3) assigning a static connection between the at least one memory request port and a request concentrator of the memory subsystem connected with the memory port of the destined memory bank when generating the RTL circuit model.

16. The computer-implemented method of claim 13, wherein step (c) comprises the following steps:
c1) generating a custom memory block corresponding to each data member of the data structure;
c2) editing configurable parameters of each memory block based on the requirements of the set of accelerated functions, wherein the configurable parameters include one or more of memory type, memory depths and widths, number of read/write ports associated with the memory block, and connections with at least one of the accelerator units and/or at least one processing unit.

17. A heterogeneous architecture system comprising
a) at least one processing unit comprising a processing core and at least one memory request port connected to the processing core;
b) a plurality of accelerator units each comprising an accelerator core and at least one memory request port connected to the accelerator core;
c) a memory subsystem comprising:
a plurality of memory groups, wherein each memory group comprises a plurality of memory banks of a single memory type;
a plurality of memory ports, wherein each memory port is configured to connect with one of the memory banks; and
a plurality of request concentrators, wherein each request concentrator is configured to connect one of the memory ports with at least one memory request port of the at least one processing unit and/or at least one memory request port of at least one of the accelerator units, such that the at least one processing unit and/or the at least one of the accelerator units can access the plurality of memory banks concurrently.

18. The system of claim 17,
wherein each of the memory banks comprises a plurality of memory words,
wherein each of the memory words is associated with a distinct global address, and each of the memory groups is assigned with a distinct global address range covering the global addresses of all memory words of the memory banks within the memory group,
wherein the system further comprises an address decoder, wherein upon receiving an input global address in a memory request made by the at least one processing unit and/or at least one of the accelerator units to access a target memory word in a target memory bank within a target memory group, the address decoder is configured to locate the target memory bank and the target memory word using an address decoding scheme comprising the following steps:
comparing the input global address against the global address range assigned to each of the memory groups to determine the target memory group that associates with the input global address;
and
decoding a bank index and a bank address from the input global address, wherein the bank index identifies the target memory bank within the target memory group and the bank address identifies the location of the target memory word within the target memory bank.

19. The system of claim 18, wherein the input global address comprises a set of address bits having a least significant segment, a most significant segment and a middle segment, and wherein the memory type of each of the memory groups is a register-file bank or a cache bank,
wherein if the memory type of the target memory group is the register-file bank, the least significant segment determines the bank index and the middle segment determines the bank address; and
if the memory type of the target memory group is the cache bank, the middle segment determines the bank index while the least significant segment determines the bank address.

20. The system of claim 17, wherein the plurality of request concentrators are connected with the at least one processing unit and the plurality of accelerator units via a static connection and/or a dynamic connection,
wherein one or more of the request concentrators connect with the at least one processing unit and one or more of the accelerator units by the dynamic connection configured with a memory switch at a run time; and
wherein one or more of the request concentrators connect with one or more of the accelerator units via the static connection.
